(19) United States
(12) Patent Application Publication
(10) Pub. No.: US 2020/0207915 A1
(43) Pub. Date: Jul. 2, 2020

(54) RESIN COMPOSITION, METHOD OF PRODUCING RESIN FILM, AND METHOD OF PRODUCING ELECTRONIC DEVICE

(71) Applicant: Toray Industries, Inc., Tokyo (JP)

(72) Inventors: Tomoki Ashibe, Otsu-shi, Shiga (JP); Koji Ueoka, Otsu-shi, Shiga (JP)

(73) Assignee: Toray Industries, Inc., Tokyo (JP)

(21) Appl. No.: 16/642,539

(22) PCT Filed: Jul. 19, 2018
(86) PCT No.: PCT/JP2018/027032

§ 371 Date: Feb. 27, 2020

(30) Foreign Application Priority Data
Sep. 7, 2017 (JP) 2017-171767

(51) Int. Cl. C08G 73/10; C08J 5/18

(52) U.S. Cl. CPC C08G 73/1067; C08J 2379/08; C08J 5/18; C08G 73/1082

(57) ABSTRACT

A resin composition comprising (a) at least one resin selected from polyimides and polyimide precursors, and (b) a solvent, wherein the loss tangent (tan δ), represented by the following formula (I) and determined by a dynamic viscoelasticity measurement under the conditions of a temperature of 22° C. and an angular frequency of 10 rad/s, is 150 or more and less than 550, provides a resin composition which has no defects such as rupture of the film when the coated film is dried under reduced pressure, and has good film thickness uniformity and mechanical properties when formed into a film.

tan δ=G″/G′ (I)

(wherein G′ represents the storage elastic modulus of the resin composition, and G″ represents the loss elastic modulus of the resin composition.)

### CROSS REFERENCE TO RELATED APPLICATIONS

This is the U.S. National Phase application of PCT/JP2018/027032, filed Jul. 19, 2018, which claims priority to Japanese Patent Application No. 2017-171767, filed Sep. 7, 2017, the disclosures of each of these applications being incorporated herein by reference in their entireties for all purposes.

### FIELD OF THE INVENTION

The present invention relates to a resin composition, a method of producing a resin film, and a method of producing an electronic device.

### BACKGROUND OF THE INVENTION

Polyimides are used as a material for various electronic devices such as semiconductors and displays due to their excellent electrical insulation, heat resistance, and mechanical properties. Recently, the development of flexible electronic devices that are resistant to impact has been promoted by using a heat resistant resin film for a substrate of an image display device such as an organic EL display, an electronic paper, and a color filter, and of a touch panel.

In general, since polyimides are often insoluble in a solvent and infusible by heat, their direct molding process is difficult. Therefore, in film formation, it is common to apply a solution containing polyamic acid, which is a polyimide precursor (hereinafter referred to as varnish), and then convert it to a polyimide film by baking.

As a resin composition suitable for a substrate of a flexible electronic device, a resin composition is disclosed in which both good coating property and high mechanical properties when formed into a film are achieved by protecting the terminal end of the amino group of the polyamic acid with a thermolabile protecting group (see, for example, Patent Document 1 and Patent Document 2).

### PRIOR ART REFERENCES

### Patent Documents

### [PATENT DOCUMENT 1] JP5472540A

### [PATENT DOCUMENT 2] JP6241557A

### SUMMARY OF THE INVENTION

The prepared varnish is coated onto a support substrate by spin coating, slit coating, ink jet coating, or the like. Since the film immediately after being coated contains a large amount of solvent, it is necessary to quickly remove the solvent and dry the film. If the film immediately after being coated is directly dried by heating, the dry condition on the film surface becomes uneven due to the effect of thermal convection, resulting in poor film thickness uniformity. Thus, adverse effects such as wire breaks and cracks will be caused when an electronic device is formed on the film. Therefore, when a substrate of a flexible electronic device is produced, after a varnish is coated on the substrate, the varnish is preferably dried first under reduced pressure and then subjected to drying by heating as necessary.

However, in conventional polyamic acid resin compositions, when the coated resin composition is dried under reduced pressure before being dried by heating, the drying proceeds only on the surface of the coated film to form a surface thin layer. Thus, rupture of the film due to solvent boiling from the inside of the coated resin composition has been a problem.

As a result of dedicated studies, the present inventors have come to the conclusion that, in order to avoid the formation of a surface thin layer in the drying step under reduced pressure, it is not sufficient to reduce the viscosity of the coating fluid. The present inventors have found that, by adjusting the molecular weight of the resin, the viscosity of the resin composition and the like in such a way that the loss elastic modulus (viscous component) of the coating fluid is sufficiently larger than the storage elastic modulus (elastic component) in a dynamic viscoelasticity measurement, the fluidity of the coated film during drying under reduced pressure can be ensured and the rupture of the film can be suppressed.

Based on this knowledge, the present invention aims to provide a resin composition which has no defect such as rupture of the film when the coated film is dried under reduced pressure, and has good film thickness uniformity and mechanical properties when formed into a film.

That is, the present invention according to exemplary embodiments is a resin composition comprising (a) at least one resin selected from polyimides and polyimide precursors, and (b) a solvent, wherein the loss tangent (tan δ), represented by the following formula (I) and determined by a dynamic viscoelasticity measurement under the conditions of a temperature of 22° C. and an angular frequency of 10 rad/s, is 150 or more and less than 550.

tan δ=G″/G′ (I)

wherein G′ represents the storage elastic modulus of the resin composition, and G″ represents the loss elastic modulus of the resin composition.

The present invention according to exemplary embodiments is also a resin composition comprising (a) at least one resin selected from polyimides and polyimide precursors, and (b) a solvent, wherein V and M satisfy the following formula (II) with V being the viscosity (cp) at 25° C. and M being the weight average molecular weight of the component (a).

0.3≤(M−10,000)×V^{2.5}×10⁻¹²≤10 (II)

According to the present invention, a resin composition which is suitable for the production of a flexible resin substrate, has no defect such as rupture of the film upon drying under reduced pressure, and has good film thickness uniformity and mechanical properties when formed into a film can be obtained.

### DETAILED DESCRIPTION OF EMBODIMENTS OF THE INVENTION

One embodiment of the present invention is a resin composition comprising (a) at least one resin selected from polyimides and polyimide precursors, and (b) a solvent, wherein the loss tangent (tan δ), represented by the following formula (I) and determined by a dynamic viscoelasticity measurement under conditions of a temperature of 22° C. and an angular frequency of 10 rad/s, is 150 or more and less than 550.

tan δ=G″/G′ (I)

wherein G′ represents the storage elastic modulus of the resin composition, and G″ represents the loss elastic modulus of the resin composition.

Another embodiment of the present invention is also a resin composition comprising (a) at least one resin selected from polyimides and polyimide precursors, and (b) a solvent, wherein V and M satisfy the following formula (II) with V being the viscosity (cp) at 25° C. and M being the weight average molecular weight of the component (a).

0.3≤(M−10,000)×V^{2.5}×10⁻¹²≤10 (II)

### Dynamic Viscoelasticity

Tan δ is a ratio between a storage elastic modulus (G′) corresponding to the elasticity of the varnish and a loss elastic modulus (G″) corresponding to the viscosity of the varnish (G″/G′). A larger tan δ indicates a greater viscosity with respect to the elasticity, and a smaller tan δ indicates a larger elasticity with respect to the viscosity.

When a resin composition is coated onto a substrate and dried under reduced pressure, insufficient viscosity of the resin composition with respect to the elasticity results in insufficient fluidity of the coated film during drying. Thus, the drying on the surface of the coated film proceeds, causing a rough surface. In addition, problems such as rupture of the film due to bumping of the solvent remaining inside the coated film occur. On the other hand, when the viscosity is too large with respect to the elasticity, there is a problem of deterioration of the film thickness uniformity because the coated film flows at the edges after the varnish is coated and before the varnish is dried, thus resulting in a thinner film.

In the resin composition according to an embodiment of the present invention, by setting the tan δ measured under conditions of a temperature of 22° C. and an angular frequency of 10 rad/sec to be 150 or more, the coated film has appropriate fluidity, and a rough surface and the rupture of the film during drying under reduced pressure can be suppressed. Moreover, since moderate elasticity can be also provided by setting the tan δ measured under the same conditions to be less than 550, a resin film which has high film thickness uniformity is obtained without having thinned edges of the coated film.

In order to avoid a surface thin layer during drying under reduced pressure, the tan δ is preferably 180 or more, and more preferably 200 or more. In order to ensure the shape at the edges of the coated film, the tan δ is preferably 500 or less, and more preferably 480 or less.

### Relationship of the Weight Average Molecular Weight and Viscosity

In the formula (II) above described, (M−10,000)×V^{2.5}×10⁻¹² is a parameter obtained by multiplying the term (M−10,000) which is related to the weight average molecular weight and the term (V^{2.5}) which is related to the viscosity.

For the term related to the weight average molecular weight (M−10,000), a larger weight average molecular weight means more interaction of the resins. The same term also means that little interaction is present between resins when the weight average molecular weight is 10,000 or less, and as described later, the deterioration of the film thickness uniformity due to the flow of the coated film at the edges during drying under reduced pressure is difficult to suppress. Excluding the influence of concentration, it is presumed that the larger the weight average molecular weight is, the more interaction points between the resins are present, resulting in more interaction.

For the term related to the viscosity (V^{2.5}), a larger viscosity means more interaction of the resins. Excluding the influence of the weight average molecular weight, the higher the concentration of the resin composition is, the higher the viscosity is. In addition, it is considered that the interaction points of the resin increase rapidly as the concentration increases. Therefore, it is presumed that a higher viscosity results in more interaction of the resins. The value of the viscosity of the resin composition varies depending on the type of the solvent to be contained and the type of the resin even if the weight average molecular weight and concentration of the resin are constant. This is because the form of the resin in the solution varies depending on the rigidity of the resin and the magnitude of the interaction between the resin and the solvent. That is, it is presumed that higher viscosity indicates a form that results in more interaction of resins.

As described above, the term of weight average molecular weight (M−10,000) and the term of viscosity (V^{2.5}) are individually terms which reflect the degree of interaction of resins, respectively, and a parameter obtained by multiplication of these (M−10,000)×V^{2.5}×10⁻¹² is also estimated to be a parameter that reflects the degree of interaction of resins in the resin composition.

When the resin composition is coated onto a substrate and dried under reduced pressure, if there is too little interaction of the resins in the resin composition, there is a problem of deterioration of the film thickness uniformity because the coated film flows at the edges after the varnish is coated and before the varnish is dried, thus resulting in a thinner film. If there is too much interaction of the resins, the solvent inside the resin film is difficult to dry, and drying proceeds only on the surface of the coated film, causing a rough surface. In addition, problems such as rupture of the film due to bumping of the solvent remaining inside the coated film occur.

In the resin composition of the present invention, if V and M satisfy 0.3≤(M−10,000)×V^{2.5}×10⁻¹²≤10, the resins in the resin composition have sufficient interaction. Thus, upon drying under reduced pressure, the deterioration of the film thickness uniformity due to the flow of the coated film at the edges can be suppressed. This also means that it is difficult to suppress the deterioration of the film thickness uniformity when the weight average molecular weight is 10,000 or less. In addition, if V and M satisfy (M−10,000)×V^{2.5}×10⁻¹²≤10, the interaction of the resins can be moderately suppressed. Therefore, the solvent is unlikely to remain inside the resin during drying under reduced pressure, and a rough surface and rupture of the film can be suppressed. V and M more preferably satisfy (M−10,000)×V^{2.5}×10⁻¹²≤8 because the solvent is more unlikely to remain during drying under reduced pressure, and thus the drying time can be shortened.

A more preferred embodiment of the present invention is a resin composition in which the loss tangent (tan δ) represented by the above formula (I) is 150 or more and less than 550, and V and M satisfy the above formula (II). If V and M satisfy 0.3≤(M−10,000)×V^{2.5}×10⁻¹²≤10, it is easy to adjust the tan δ of the resin composition to less than 550, and a resin film having excellent film thickness uniformity can be obtained. If V and M satisfy (M−10,000)×V^{2.5}×10⁻¹²≤10, the tan δ of the resin composition can be easily adjusted to 150 or more, and a rough surface and rupture of the film during drying under reduced pressure can be suppressed. A larger value of (M−10,000)×V^{2.5}×10⁻¹² is likely to result in a smaller value of tan δ while a smaller value of (M−10,000)×V^{2.5}×10⁻¹² is likely to result in a larger value of tan δ.

### Polyimides and Polyimide Precursors

In the present invention, (a) at least one resin selected from polyimides and polyimide precursors may comprise only one type of resin, or two or more types of resins may be mixed. The polyimides and the polyimide precursors may each contain a single repeating unit or may be a copolymer having two or more repeating units.

Polyimide is a resin having a cyclic structure of an imide ring in the main chain structure. Polyimides can be obtained by reacting tetracarboxylic acid or corresponding tetracarboxylic dianhydride, tetracarboxylic acid diester chloride, or the like with a diamine or a corresponding diisocyanate compound, or a trimethylsilylated diamine, and thus have a tetracarboxylic acid residue and a diamine residue.

For example, a polyamic acid, which is one of the polyimide precursors and is obtained by reacting tetracarboxylic dianhydride with a diamine, can be subjected to dehydration ring closure by a heat treatment to obtain a polyimide. During this heat treatment, a solvent azeotropic with water such as m-xylene can be added. Alternatively, polyimide can be also obtained by adding a dehydration-condensation agent such as a carboxylic anhydride or dicyclohexylcarbodiimide, and a base such as triethylamine as a ring-closing catalyst to perform dehydration ring closure by a chemical heat treatment. Alternatively, polyimide can be also obtained by adding a weakly acidic carboxylic acid compound and carrying out the dehydration ring closure by a heat treatment at a low temperature of 100° C. or less.

The polyimide precursors are resins having an amide bond in the main chain and undergo dehydration ring closure through a heat treatment or a chemical treatment to form the polyimide as described above. Examples of polyimide precursors include polyamic acids, polyamic acid esters, polyamic acid amides, polyisoimides and the like. Polyamide acids and polyamic acid esters are preferred.

The weight average molecular weight of a polyimide and a polyimide precursor is preferably 20,000 or more and less than 40,000. As the weight average molecular weight is smaller, the tan δ tends to increase in the viscoelasticity measurement of the resin composition. A weight average molecular weight of less than 40,000 is preferred because the tan δ tends to be 150 or more and the fluidity of the resin composition is easily ensured. A weight average molecular weight of 20,000 or more is preferred because a resin film having high mechanical strength is obtained.

The weight average molecular weight of a polyimide and a polyimide precursor can be determined by a gel permeation chromatography (GPC). Specifically, the weight average molecular weight can be measured using a solvent in which the compound is dissolved, for example, N-methyl-2-pyrrolidone as a mobile phase; polystyrene as a standard; and TOSOH TXK-GEL α-2500 and/or α-4000 manufactured by Tosoh Corporation as a column.

The component (a) preferably contains a resin represented by the following general formula (1).

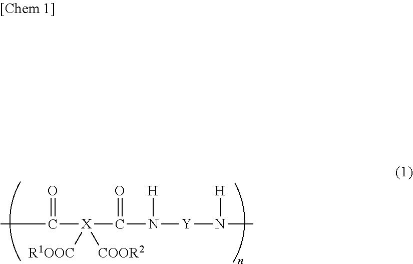

In the general formula (1), X represents a tetravalent tetracarboxylic acid residue having 2 or more carbon atoms, and Y represents a divalent diamine residue having 2 or more carbon atoms. n represents a positive integer. R¹ and R² represent each independently a hydrogen atom, a hydrocarbon group having 1 to 10 carbon atoms, or an alkylsilyl group having 1 to 10 carbon atoms.

The general formula (1) shows the structure of polyamic acid. The polyamic acid is obtained by reacting tetracarboxylic acid and a diamine compound. Furthermore, the polyamic acid can be converted into polyimide, which is a heat resistant resin, by heating or by chemical treatment.

In the general formula (1), X is preferably a tetravalent hydrocarbon group having 2 to 80 carbon atoms. X may also be a tetravalent organic group having 2 to 80 carbon atoms, which contains a hydrogen atom and a carbon atom as essential components and contains one atom or more selected from the group consisting of boron, oxygen, sulfur, nitrogen, phosphorus, silicon and halogen. Boron, oxygen, sulfur, nitrogen, phosphorus, silicon, and halogen atoms are each independently preferably in the range of 20 or less, more preferably in the range of 10 or less.

Examples of tetracarboxylic acids that give X include the following.

As aromatic tetracarboxylic acids, monocyclic aromatic tetracarboxylic acid compounds, for example, pyromellitic acid and 2,3,5,6-pyridinetetracarboxylic acid, various isomers of biphenyltetracarboxylic acid, for example, 3,3′,4,4′-biphenyltetracarboxylic acid, 2,3,3′,4′-biphenyltetracarboxylic acid, 2,2′,3,3′-biphenyltetracarboxylic acid, 3,3′,4,4′-benzophenone tetracarboxylic acid, and 2,2′,3,3′-benzophenone tetracarboxylic acid, and the like;

bis(dicarboxyphenyl) compounds, for example, 2,2-bis(3,4-dicarboxyphenyl)hexafluoropropane, 2,2-bis(2,3-dicarboxyphenyl)hexafluoropropane, 2,2-bis(3,4-dicarboxyphenyl)propane, 2,2-bis(2,3-dicarboxyphenyl)propane, 1,1-bis(3,4-dicarboxyphenyl)ethane, 1,1-bis(2,3-dicarboxyphenyl)ethane, bis(3,4-dicarboxyphenyl)methane, bis(2,3-dicarboxyphenyl)methane, bis(3,4-dicarboxyphenyl)sulfone, bis(3,4-dicarboxyphenyl)ether and the like;
bis(dicarboxyphenoxyphenyl) compounds, for example, 2,2-bis[4-(3,4-dicarboxyphenoxy)phenyl]hexafluoropropane, 2,2-bis[4-(2,3-dicarboxyphenoxy)phenyl]hexafluoropropane, 2,2-bis[4-(3,4-dicarboxyphenoxy)phenyl]propane, 2,2-bis[4-(2,3-dicarboxyphenoxy)phenyl]propane, 2,2-bis[4-(3,4-dicarboxyphenoxy)phenyl]sulfone, 2,2-bis[4-(3,4-dicarboxyphenoxy)phenyl]ether and the like;
various isomers of naphthalene tetracarboxylic acid or condensed polycyclic aromatic tetracarboxylic acid, for example, 1,2,5,6-naphthalenetetracarboxylic acid, 1,4,5,8-naphthalenetetracarboxylic acid, 2,3,6,7-naphthalenetetracarboxylic acid, 2,3,6,7-naphthalenetetracarboxylic acid, 3,4,9,10-perylenetetracarboxylic acid, and the like; bis(trimellitic acid monoester) compounds, for example, p-phenylenebis(trimellitic acid monoester), p-biphenylenebis(trimellitic acid monoester), ethylenebis(trimellitic acid monoester), bisphenol A bis(trimellitic acid monoester), and the like; are included.

As aliphatic tetracarboxylic acids, chain aliphatic tetracarboxylic acid compounds, for example, butanetetracarboxylic acid and the like; alicyclic tetracarboxylic acid compounds, for example, cyclobutanetetracarboxylic acid, 1,2,3,4-cyclopentanetetracarboxylic acid, 1,2,4,5-cyclohexanetetracarboxylic acid, bicyclo[2.2.1.]heptanetetracarboxylic acid, bicyclo[3.3.1.]tetracarboxylic acid, bicyclo[3.1.1.]hept-2-enetetracarboxylic acid, bicyclo[2.2.2.]octanetetracarboxylic acid, adamantanetetracarboxylic acid, and the like;

are included.

These tetracarboxylic acid components can be used directly or as acid anhydrides, active esters or active amides. Among these, acid anhydrides are preferably used because no by-products are produced during polymerization. Two kinds or more of these may be also used.

Among these, from the viewpoint of heat resistance of the resin film obtained by curing a resin having a structure represented by the general formula (1), the tetracarboxylic acid that gives X is preferably an aromatic tetracarboxylic acid. Furthermore, X is preferably selected from any of the following tetravalent tetracarboxylic acid residues since the coefficient of thermal expansion of the resulting resin film can be kept low.

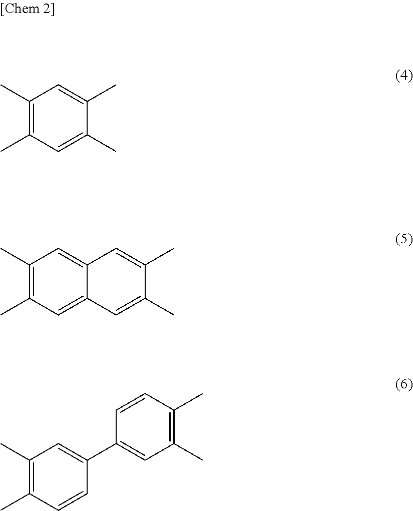

In order to improve the coating property to the support and resistance to oxygen plasma and a UV ozone treatment used for cleaning or the like, silicon-containing tetracarboxylic acids such as dimethylsilane diphthalic acid and 1,3-bis(phthalic acid)tetramethyldisiloxane can also be used. When any of these silicon-containing tetracarboxylic acids is used, the silicon-containing tetracarboxylic acid is preferably used in the amount of 1 to 30 mol % of the total tetracarboxylic acid.

In the tetracarboxylic acid described above, the hydrogen atoms contained in the tetracarboxylic acid residues may be partially substituted by a hydrocarbon group having 1 to 10 carbon atoms such as a methyl group or an ethyl group, a fluoroalkyl group having 1 to 10 carbon atoms such as a trifluoromethyl group, or a group such as F, Cl, Br, I. Furthermore, substitution with an acidic group such as OH, COOH, SO₃H, CONH₂, or SO₂NH₂ improves the solubility of the resin in an alkaline aqueous solution, and thus is preferred when the resin is used as a photosensitive resin composition as described later.

In the general formula (1), Y is preferably a divalent hydrocarbon group having 2 to 80 carbon atoms. Y may also be a divalent organic group having 2 to 80 carbon atoms, which contains a hydrogen atom and a carbon atom as essential components and contains one atom or more selected from the group consisting of boron, oxygen, sulfur, nitrogen, phosphorus, silicon and halogen. Preferably, boron, oxygen, sulfur, nitrogen, phosphorus, silicon, and halogen atoms are each independently in the range of 20 or less, and more preferably in the range of 10 or less.

Examples of diamines that give Y include the following.

As diamine compounds containing an aromatic ring, monocyclic aromatic diamine compounds, for example, m-phenylenediamine, p-phenylenediamine, 3,5-diaminobenzoic acid and the like;

naphthalene diamine compounds or condensed polycyclic aromatic diamine compounds, for example, 1,5-naphthalenediamine, 2,6-naphthalenediamine, 9,10-anthracenediamine, 2,7-diaminofluorene, and the like;
bis(diaminophenyl) compounds or various derivatives thereof, for example, 4,4′-diaminobenzanilide, 3,4′-diaminodiphenyl ether, 4,4′-diaminodiphenyl ether, 3-carboxy-4,4′-diaminodiphenyl ether, 3-sulfonic acid-4,4′-diaminodiphenyl ether, 3,4′-diaminodiphenylmethane, 4,4′-diaminodiphenylmethane, 3,4′-diaminodiphenylsulfone, 4,4′-diaminodiphenylsulfone, 3, 4′-diaminodiphenyl sulfide, 4,4′-diaminodiphenyl sulfide, 4-aminobenzoic acid 4-aminophenyl ester, 9,9-bis(4-aminophenyl)fluorene, 1,3-bis(4-anilino)tetramethyldisiloxane, and the like; 4,4′-diaminobiphenyl or various derivatives thereof, for example, 4,4′-diaminobiphenyl, 2,2′-dimethyl-4,4′-diaminobiphenyl, 2,2′-diethyl-4,4′-diaminobiphenyl, 3,3′-dimethyl-4,4′-diaminobiphenyl, 3,3′-diethyl-4,4′-diaminobiphenyl, 2,2′,3,3′-tetramethyl-4,4′-diaminobiphenyl, 3,3′,4,4′-tetramethyl-4,4′-diaminobiphenyl, 2,2′-di(trifluoromethyl)-4,4′-diaminobiphenyl, and the like;
bis(aminophenoxy) compounds, for example, bis(4-aminophenoxyphenyl)sulfone, bis(3-aminophenoxyphenyl)sulfone, bis(4-aminophenoxy)biphenyl, bis[4-(4-aminophenoxy)phenyl]ether, 2,2-bis[4-(4-aminophenoxy)phenyl]propane, 2,2-bis[4-(4-aminophenoxy)phenyl]hexafluoropropane, 1,4-bis(4-aminophenoxy)benzene, 1,3-bis(3-aminophenoxy)benzene, 1,3-bis(4-aminophenoxy)benzene and the like;
bis(3-amino-4-hydroxyphenyl) compounds, for example, bis(3-amino-4-hydroxyphenyl)hexafluoropropane, bis(3-amino-4-hydroxyphenyl)sulfone, bis(3-amino-4-hydroxyphenyl)propane, bis(3-amino-4-hydroxyphenyl)methylene, bis(3-amino-4-hydroxyphenyl)ether, bis(3-amino-4-hydroxy)biphenyl, 9,9-bis(3-amino-4-hydroxyphenyl)fluorene and the like;
bis(aminobenzoyl) compounds, for example, 2,2′-bis[N-(3-aminobenzoyl)-3-amino-4-hydroxyphenyl]hexafluoropropane, 2,2′-bis[N-(4-aminobenzoyl)-3-amino-4-hydroxyphenyl]hexafluoropropane, 2,2′-bis[N-(3-aminobenzoyl)-3-amino-4-hydroxyphenyl]propane, 2,2′-bis[N-(4-aminobenzoyl)-3-amino-4-hydroxyphenyl]propane, bis[N-(3-aminobenzoyl)-3-amino-4-hydroxyphenyl]sulfone, bis[N-(4-aminobenzoyl)-3-amino-4-hydroxyphenyl]sulfone, 9,9-bis[N-(3-aminobenzoyl)-3-amino-4-hydroxyphenyl]fluorene, 9,9-bis[N-(4-aminobenzoyl)-3-amino-4-hydroxyphenyl]fluorene, N,N′-bis(3-aminobenzoyl)-2,5-diamino-1,4-dihydroxybenzene, N,N′-bis(4-aminobenzoyl)-2,5-diamino-1,4-dihydroxybenzene, N,N′-bis(3-aminobenzoyl)-4,4′-diamino-3,3-dihydroxybiphenyl, N,N′-bis(4-aminobenzoyl)-4,4′-diamino-3,3-dihydroxybiphenyl, N,N′-bis(3-aminobenzoyl)-3,3′-diamino-4,4-dihydroxybiphenyl, N,N′-bis(4-aminobenzoyl)-3,3′-diamino-4,4-dihydroxybiphenyl and the like;
heterocycle-containing diamine compounds, for example, 2-(4-aminophenyl)-5-aminobenzoxazole, 2-(3-aminophenyl)-5-aminobenzoxazole, 2-(4-aminophenyl)-6-aminobenzoxazole, 2-(3-aminophenyl)-6-aminobenzoxazole, 1,4-bis(5-amino-2-benzoxazolyl)benzene, 1,4-bis(6-amino-2-benzoxazolyl)benzene, 1,3-bis(5-amino-2-benzoxazolyl)benzene, 1,3-bis(6-amino-2-benzoxazolyl)benzene, 2,6-bis(4-aminophenyl)benzobisoxazole, 2,6-bis(3-aminophenyl)benzobisoxazole, 2,2′-bis[(3-aminophenyl)-5-benzoxazolyl]hexafluoropropane, 2,2′-bis[(4-aminophenyl)-5-benzoxazolyl]hexafluoropropane, bis[(3-aminophenyl)-5-benzoxazolyl], bis[(4-aminophenyl)-5-benzoxazolyl], bis[(3-aminophenyl)-6-benzoxazolyl], bis[(4-aminophenyl)-6-benzoxazolyl] and the like;
or compounds in which the hydrogen atoms bonded to the aromatic ring contained in these diamine compounds are partially substituted by a hydrocarbon group or halogen, and the like; are included.

As aliphatic diamine compounds, linear diamine compounds, for example, ethylenediamine, propylenediamine, butanediamine, pentanediamine, hexanediamine, octanediamine, nonanediamine, decanediamine, undecanediamine, dodecanediamine, tetramethylhexanediamine, 1,12-(4,9-dioxa)dodecanediamine, 1,8-(3,6-dioxa)octanediamine, 1,3-bis(3-aminopropyl)tetramethyldisiloxane and the like; cycloaliphatic diamine compounds, for example, cyclohexanediamine, 4,4′-methylenebis(cyclohexylamine), isophoronediamine, and the like; polyoxyethyleneamine and polyoxypropyleneamine known as Jeffamine (trade name, manufactured by Huntsman Corporation), their copolymerized compounds, and the like; are included.

These diamines can be used directly or as corresponding trimethylsilylated diamines. Two kinds or more of these may be also used.

Among these, from the viewpoint of heat resistance of the resin film obtained by curing a resin having a structure represented by the general formula (1), the diamine that gives Y is preferably an aromatic diamine. Furthermore, Y is preferably selected from any of the following divalent diamine residues since the coefficient of thermal expansion of the resulting resin film can be kept low.

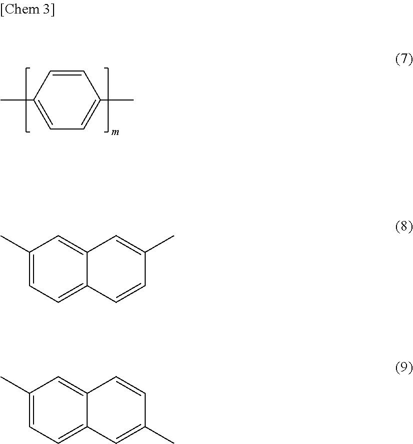

m represents a positive integer.

Particularly preferably, X in the general formula (1) is selected from any of tetravalent tetracarboxylic acid residues represented by the chemical formulas (4) to (6), and Y is selected from any of the divalent diamine residues represented by the chemical formulas (7) to (9).

In order to improve the coating property to the support and resistance to oxygen plasma and a UV ozone treatment used for cleaning or the like, silicon-containing diamines such as 1,3-bis(3-aminopropyl)tetramethyldisiloxane and 1,3-bis(4-anilino)tetramethyldisiloxane can also be used. When any of these silicon-containing diamine compounds is used, the silicon-containing diamine compound is preferably used in the amount of 1 to 30 mol % of the total diamine compound.

In the diamine compound described above, the hydrogen atoms contained in the diamine compound may be partially substituted by a hydrocarbon group having 1 to 10 carbon atoms such as a methyl group or an ethyl group, a fluoroalkyl group having 1 to 10 carbon atoms such as a trifluoromethyl group, or a group such as F, Cl, Br, I. Furthermore, substitution with an acidic group such as OH, COOH, SO₃H, CONH₂, or SO₂NH₂ improves the solubility of the resin in an alkaline aqueous solution, and thus is preferred when the resin is used as a photosensitive resin composition as described later.

When the terminal monomer of the polyimide precursor is a diamine compound, dicarboxylic anhydride, monocarboxylic acid, a monocarboxylic acid chloride compound, an active ester compound of monocarboxylic acid, dialkyl dicarbonate ester or the like can be used as a terminal blocking agent to block the amino group.

When a polyimide precursor which is blocked at the terminal amino group is contained, the resin represented by the general formula (1) contained in the component (a) is preferably a resin represented by the following general formula (2).

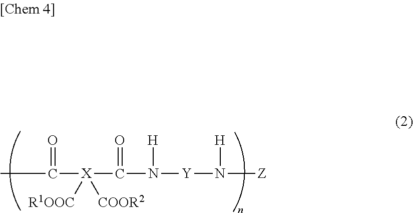

In the general formula (2), X, Y, R′, R² and n are the same as those in the general formula (1). Z represents the terminal structure of the resin and is a structure represented by the chemical formula (10).

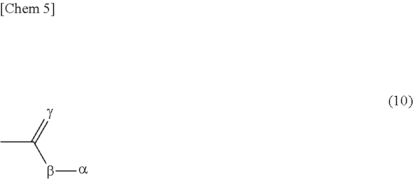

In the chemical formula (10), a represents a monovalent hydrocarbon group having 2 or more carbon atoms, and β and γ represent each independently an oxygen atom or a sulfur atom.

In the chemical formula (10), a is preferably a monovalent hydrocarbon group having 2 to 10 carbon atoms. Preferably, α is an aliphatic hydrocarbon group, and may be any of linear, branched or cyclic.

Examples of such hydrocarbon groups include linear hydrocarbon groups such as ethyl group, n-propyl group, n-butyl group, n-pentyl group, n-hexyl group, n-heptyl group, n-octyl group, n-nonyl group, and n-decyl group, branched hydrocarbon groups such as isopropyl group, isobutyl group, sec-butyl group, tert-butyl group, isopentyl group, sec-pentyl group, tert-pentyl group, isohexyl group, and sec-hexyl group, and cyclic hydrocarbon groups such as cyclopropyl group, cyclobutyl group, cyclopentyl group, cyclohexyl group, cycloheptyl group, cyclooctyl group, norbornyl group and adamantyl group.

Among these hydrocarbon groups, a monovalent branched hydrocarbon group and cyclic hydrocarbon group having 2 to 10 carbon atoms are preferred, and an isopropyl group, a cyclohexyl group, a tert-butyl group, and a tert-pentyl group are more preferred, and a tert-butyl group is most preferred.

In the chemical formula (10), β and γ represent each independently an oxygen atom or a sulfur atom, preferably an oxygen atom.

When the polyamic acid having a structure represented by the general formula (2) is heated, Z is thermally decomposed to generate an amino group at the terminal end of the resin. The amino group generated at the terminal end can react with another resin having tetracarboxylic acid at the terminal end. For this reason, when the resin having a structure represented by the general formula (2) is heated, a polyimide resin having a high degree of polymerization is obtained. As a result, a resin film excellent in mechanical strength and bending resistance can be obtained. Moreover, the resin composition containing a polyamic acid having a structure represented by the general formula (2) has a small change rate of viscosity during long-term storage and thus excellent storage stability.

Therefore, the resin composition containing a polyamic acid having a structure represented by the general formula (2) as the component (a) is preferred because such resin composition has excellent in storage stability and facilitates the increase of the tan δ to a predetermined value before heated since the molecular weight of the component (a) can be kept low and gives a resin film which shows excellent mechanical properties and bending resistance after heated.

When the terminal monomer of the polyimide precursor is tetracarboxylic acid, monoamine, monoalcohol, water and the like can be used as a terminal blocking agent to block the carboxy group.

When a polyimide precursor which is sealed at the terminal carboxy group is contained, the resin represented by the general formula (1) contained in the component (a) is preferably a resin represented by the following general formula (3).

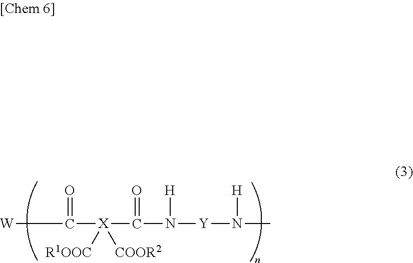

In the general formula (3), X, Y, R¹, R² and n are the same as those in the general formula (1). W represents the terminal structure of the resin and is a structure represented by the chemical formula (11).

### [Chem 7]

—ϵ—δ (11)

In the chemical formula (11), δ represents a monovalent hydrocarbon group having 1 or more carbon atoms or a hydrogen atom, and c represents an oxygen atom or a sulfur atom.

δ is preferably a monovalent hydrocarbon group having 1 to 10 carbon atoms. More preferably, δ is an aliphatic hydrocarbon group, and may be any of linear, branched or cyclic. Furthermore, δ is also preferably a hydrogen atom.

Specific preferred examples of such hydrocarbon groups include linear hydrocarbon groups such as methyl group, ethyl group, n-propyl group, n-butyl group, n-pentyl group, n-hexyl group, n-heptyl group, n-octyl group, n-nonyl group, and n-decyl group, branched hydrocarbon groups such as isopropyl group, isobutyl group, sec-butyl group, tert-butyl group, isopentyl group, sec-pentyl group, tert-pentyl group, isohexyl group, and sec-hexyl group, and cyclic hydrocarbon groups such as cyclopropyl group, cyclobutyl group, cyclopentyl group, cyclohexyl group, cycloheptyl group, cyclooctyl group, norbornyl group and adamantyl group.

In the chemical formula (11), ϵ represents an oxygen atom or a sulfur atom, preferably an oxygen atom.

When the polyamic acid having a structure represented by the general formula (3) is heated, W is removed to generate an acid anhydride group at the terminal end of the resin. The acid anhydride group generated at the terminal end can react with another resin having a diamine at the terminal end. For this reason, when the resin having a structure represented by the general formula (3) is heated, a polyimide resin having a high degree of polymerization is obtained. As a result, a resin film excellent in mechanical strength and bending resistance can be obtained.

Therefore, the resin composition containing a polyamic acid having a structure represented by the general formula (3) as the component (a) is preferred because a resin film is obtained, which facilitates the increase of the tan δ to a predetermined value before heated since the molecular weight of the component (a) can be kept low, and which shows excellent mechanical properties and bending resistance after heated.

The concentration of the resin having a structure represented by the general formula (2) or the general formula (3) in the resin composition is preferably 3% by weight or more, and more preferably 5% by weight or more in 100% by weight of the resin composition. Moreover, the concentration of the resin having a structure represented by the general formula (2) or the general formula (3) in the resin composition is preferably 10% by weight or less, and more preferably 8% by weight or less. A resin concentration of 3% by weight or more is preferred because the fluidity of the resin film can be easily kept low. Moreover, the resin concentration of 10% by weight or less is preferred because an unreacted terminal portion hardly remains when a resin film is heated, and a polyimide resin having a high degree of polymerization is easily obtained.

### (B) Solvents

Since the resin composition of the present invention contains (b) a solvent in addition to (a) at least one resin selected from polyimides and polyimide precursors, the resin composition can be used as a varnish. By coating such a varnish on various supports, a coated film containing at least one resin selected from polyimides and polyimide precursors can be formed on the supports. Furthermore, the obtained coated film can be cured by heat treatment and used as a heat resistant resin film.

Examples of the solvents include amides such as N-methyl-2-pyrrolidone, N-ethyl-2-pyrrolidone, N,N-dimethylformamide, N,N-dimethylacetamide, 3-methoxy-N,N-dimethylpropionamide, 3-butoxy-N,N-dimethylpropionamide, N-methyl-2-dimethylpropanamide, N-ethyl-2-methylpropanamide, N-methyl-2,2-dimethylpropanamide, N-methyl-2-methylbutanamide, N,N-dimethylisobutyramide, N,N-dimethyl-2-methylbutanamide, N,N-dimethyl-2,2-dimethylpropanamide, N-ethyl-N-methyl-2-methylpropanamide, N,N-dimethyl- 2-methylpentanamide, N,N-dimethyl-2,3-dimethylbutanamide, N,N-dimethyl-2-ethylbutanamide, N,N-diethyl-2-methylpropanamide, N,N-dimethyl-2,2-dimethylbutanamide, N-ethyl-N-methyl-2,2-dimethylpropanamide, N-methyl-N-propyl-2-methylpropanamide, N-methyl-N-(1-methylethyl)-2-methylpropanamide, N,N-diethyl-2,2-dimethylpropanamide, N,N-dimethyl-2,2-dimethylpentanamide, N-ethyl-N-(1-methylethyl)-2-methylpropanamide, N-methyl-N-(2-methylpropyl)-2-methylpropanamide, N-methyl-N-(1-methylethyl)-2,2-dimethylpropanamide, and N-methyl-N-(1-methylpropyl)-2-methylpropanamide, esters such as y-butyrolactone, ethyl acetate, propylene glycol monomethyl ether acetate, and ethyl lactate, ureas such as 1,3-dimethyl-2-imidazolidinone, N,N′-dimethylpropylene urea, 1,1,3,3-tetramethyl urea, sulfoxides such as dimethyl sulfoxide and tetramethylene sulfoxide, sulfones such as dimethyl sulfone and sulfolane, ketones such as acetone, methyl ethyl ketone, diisobutyl ketone, diacetone alcohol and cyclohexanone, ethers such as tetrahydrofuran, dioxane, propylene glycol monomethyl ether, propylene glycol monoethyl ether, diethylene glycol monomethyl ether, diethylene glycol monoethyl ether, diethylene glycol ethyl methyl ether, and diethylene glycol dimethyl ether, aromatic hydrocarbons such as toluene and xylene, alcohols such as methanol, ethanol and isopropanol, and water. One of these can be used alone, or two kinds or more can be used.

The preferred content of the solvent (b) is not particularly limited as long as the tan δ of the resin composition falls within a predetermined range. The content of the solvent is preferably adjusted in such a way that the concentration of the component (a) in the resin composition is 5% by weight or more and 20% by weight or less. As the concentration of the component (a) is higher, the tan δ tends to decrease. When the concentration of the component (a) is 5% by weight or more, the viscosity of the resin composition increases. Therefore, even when the weight average molecular weight of the component (a) is small, the tan δ is likely to be a value not too large, for example, less than 550. When the concentration of the component (a) is 20% by weight or less, the viscosity of the resin composition does not increase too much. Therefore, even when the weight average molecular weight of the component (a) is large, the tan δ is likely to be a value not too small, for example, 150 or more.

The solvent (b) is preferably a solvent having a boiling point of 160° C. or higher and 220° C. or lower at atmospheric pressure. This is because a surface thin layer is unlikely to be formed on the surface during drying under reduced pressure, and thus a rough film or the rupture of the film hardly occurs. The boiling point of the solvent is preferably 160° C. or higher because the progress of volatilization from the surface of the coated film can be moderately suppressed, and the surface thin layer is unlikely to be formed. In addition, the boiling point of the solvent is preferably 220° C. or lower because the solvent is less likely to condense in the drying chamber and the maintenance of the apparatus is facilitated.

Examples of solvents having a boiling point of 160° C. or higher and 220° C. or lower at atmospheric pressure include N-methyl-2-pyrrolidone, N,N-dimethylacetamide, N,N-dimethylisobutyramide, 3-methoxy-N,N-dimethylpropionamide and the like.

### Additives

The resin composition of the present invention may contain additives such as a photoacid generator, a thermal crosslinking agent, a thermal acid generator, a compound containing a phenolic hydroxyl group, an adhesion improver, inorganic particles, and a surfactant. As these additives, known compounds can be used.

### Dissolved Oxygen in the Resin Composition

The partial pressure of dissolved oxygen in the resin composition of the present invention is preferably less than 6000 Pa. Most of the gas (air) dissolved in the resin composition is nitrogen or oxygen. However, since nitrogen is an inert gas, it is difficult to accurately measure its dissolved amount. On the other hand, the amount of dissolved oxygen is easy to measure, and the ratio of the solubility of oxygen and nitrogen in the solvent is almost constant. Therefore, the amount of dissolved gas combining nitrogen and oxygen can be estimated from the amount of dissolved oxygen.

With the partial pressure of dissolved oxygen of less than 6000 Pa, when the coated film is dried under reduced pressure, defects inside the film due to the gas dissolved in the resin composition occurring as micro-sized bubbles can be prevented. This is preferred because the mechanical properties of the resin film can be improved. The lower limit value of the partial pressure of dissolved oxygen is not particularly limited, but is preferably 10 Pa or more.

As a method for measuring the partial pressure of dissolved oxygen, the partial pressure of dissolved oxygen can be measured, for example, by using a dissolved gas analyzer equipped with a dissolved oxygen sensor and immersing the measurement part of the dissolved oxygen sensor in the resin composition.

### Method of Producing a Resin Composition

Next, a method of producing the resin composition according to embodiments of the present invention will be described.

For example, a varnish which is one embodiment of the resin composition of the present invention can be obtained by dissolving the above-described component (a) and, if necessary, a photoacid generator, a thermal crosslinking agent, a thermal acid generator, a compound containing a phenolic hydroxyl group, an adhesion improver, inorganic particles and a surfactant in the solvent (b). Examples of methods for dissolution include stirring and heating. When a photoacid generator is contained, the heating temperature is preferably set within a range which does not impair the performance of the photosensitive resin composition, and is usually from a room temperature to 80° C. The order of dissolving each component is not particularly limited, and for example, there is a method of dissolving sequentially compounds in ascending order of the solubility. With respect to a component which tends to generate air bubbles at the time of dissolution under stirring such as a surfactant, such a component can be added in the end after dissolving other components to prevent poor dissolution of other components due to the generation of air bubbles.

The resin having a structure represented by the general formula (1) can be produced by a known method. For example, a polyamic acid can be obtained by polymerizing an acid component such as tetracarboxylic acid or corresponding acid dianhydride, active ester, or active amide, and a diamine component such as diamine or corresponding trimethylsilylated diamine in a reaction solvent.

The resin having a structure represented by the general formula (2) can be produced by a method as described below.

### Production Method 1:

The first production method is a method in which,
in the first stage, a diamine compound is reacted with a compound which reacts with an amino group of the diamine compound to produce a compound represented by the chemical formula (12) (hereinafter referred to as a terminal amino group blocking agent) to produce a compound represented by the chemical formula (12), and
in the second stage, the compound represented by the chemical formula (12), the diamine compound and tetracarboxylic acid are reacted to produce a resin having a structure represented by the general formula (2).

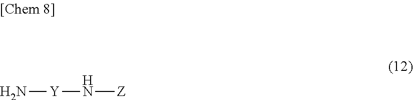

In the chemical formula (12), Y represents a divalent diamine residue having 2 or more carbon atoms. Z represents a structure represented by the chemical formula (10).

In this method, in the reaction of the first stage, the terminal amino group blocking agent is reacted with only one amino group out of the two amino groups of the diamine compound. For this reason, the following three operations are preferably performed in the reaction of the first stage.

The first operation is to use the number of moles of the diamine compound which is equal to or more than the number of moles of the terminal amino group blocking agent. The preferred number of moles of the diamine compound is 2 times or more the number of moles of the terminal amino group blocking agent, more preferably 5 times or more, and even more preferably 10 times or more. The excess diamine compound with respect to the terminal amino group blocking agent remains unreacted in the first stage reaction, and reacts with tetracarboxylic acid in the second stage.

The second operation is to gradually add the terminal amino group blocking agent over a period of 10 minutes or more to a system in which the diamine compound is dissolved in an appropriate reaction solvent. A period of 20 minutes or more is more preferred, and a period of 30 minutes or more is more preferred. In addition, the method for adding may be continuous or intermittent. That is, a method of adding to a reaction system at a constant rate using a dropping funnel or the like, or a method of adding in portions at an appropriate interval is preferably applied.

The third operation is to use the terminal amino group blocking agent dissolved in the reaction solvent in advance in the second operation. The concentration of the terminal amino group blocking agent is 5 to 20% by weight when dissolved. The concentration of the terminal amino group blocking agent is more preferably 15% by weight or less, and further more preferably 10% by weight or less.

### Production Method 2:

The second production method is a method in which,
in the first stage, a diamine compound and tetracarboxylic acid are reacted to produce a resin having a structure represented by the general formula (13), and
in the second stage, the resin having a structure represented by the general formula (13) is reacted with a terminal amino group blocking agent to produce a resin having a structure represented by the general formula (2).

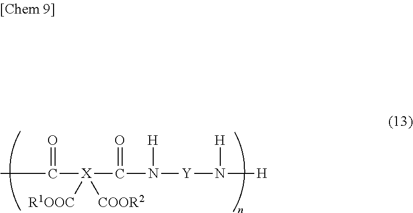

In the general formula (13), X, Y, R¹, R² and n are the same as those in the general formula (1).

In the reaction of the first stage, in order to produce a resin having a structure represented by the general formula (13), the number of moles of the diamine compound is preferably 1.01 times or more the number of moles of the tetracarboxylic acid, more preferably 1.05 times or more, further more preferably 1.1 times or more, and even more preferably 1.2 times or more. If the number of moles is less than 1.01 times, the probability that the diamine compound is located at the terminal end of the resin is reduced, and it is difficult to obtain a resin having a structure represented by the general formula (13).

In the reaction of the second stage, the method described in the production method 1 may be used as an operation for adding a terminal amino group blocking agent. That is, the terminal amino group blocking agent may be added over time, or the terminal amino group blocking agent may be dissolved in an appropriate reaction solvent and then added.

As will be described later, the number of moles of the diamine compound to be used and the number of moles of the tetracarboxylic acid to be used are preferably equal. Therefore, the tetracarboxylic acid is preferably added after the reaction of the second stage to make the number of moles of the diamine compound equal to the number of moles of tetracarboxylic acid.

Furthermore, the resin having a structure represented by the general formula (2) may be produced by using in combination the production methods 1 and 2.

As the terminal amino group blocking agent, dicarbonate ester, dithiocarbonate ester or the like is preferably used. Among these, dialkyl dicarbonate ester and dialkyl dithiocarbonate ester are preferred. Dialkyl dicarbonate ester is more preferred. Specific examples thereof include diethyl dicarbonate, diisopropyl dicarbonate, dicyclohexyl dicarbonate, di-tert-butyl dicarbonate, di-tert-pentyl dicarbonate, and the like. Among them, di-tert-butyl dicarbonate is most preferred.

In addition, in the production method as described above, as the tetracarboxylic acid, corresponding acid dianhydride, active ester, active amide, or the like can also be used. In addition, as the diamine compound, corresponding trimethylsilylated diamine or the like can also be used. In addition, the carboxy group of the obtained resin may form a salt with an alkali metal ion, ammonium ion or imidazolium ion, or may be esterified with a hydrocarbon group having 1 to 10 carbon atoms or an alkylsilyl group having 1 to 10 carbon atoms.

The number of moles of the diamine compound to be used and the number of moles of the tetracarboxylic acid to be used are preferably equal. If they are equal, a resin film having high mechanical properties is easily obtained from the resin composition.

The resin having a structure represented by the general formula (3) can be produced by a method as described below.

### Production Method 3:

The first production method is a method in which,
in the first stage, a tetracarboxylic dianhydride is reacted with a compound which reacts with an acid dianhydride group of the tetracarboxylic dianhydride to produce a compound represented by the chemical formula (14) (hereinafter referred to as a terminal carbonyl group blocking agent) to produce a compound represented by the chemical formula (14), and
in the second stage, the compound represented by the chemical formula (14), a diamine compound and tetracarboxylic acid are reacted to produce a resin having a structure represented by the general formula (3).

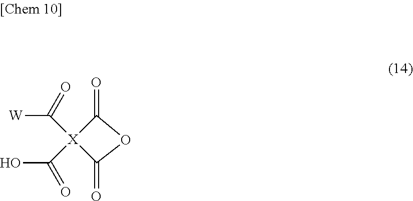

In the chemical formula (14), X represents a tetravalent tetracarboxylic acid residue having 2 or more carbon atoms. W represents a structure represented by the chemical formula (11).

In this method, in the reaction of the first stage, the terminal carbonyl group blocking agent is reacted with only one acid anhydride group out of the two acid anhydride groups of the tetracarboxylic dianhydride. For this reason, the following three operations are preferably performed in the reaction of the first stage.

The first operation is to use the number of moles of the tetracarboxylic dianhydride which is equal to or more than the number of moles of the terminal carbonyl group blocking agent. The preferred number of moles of the tetracarboxylic dianhydride is 2 times or more the number of moles of the terminal carbonyl group blocking agent, more preferably 5 times or more, and even more preferably 10 times or more. The excess tetracarboxylic dianhydride with respect to the terminal carbonyl group blocking agent remains unreacted in the first stage reaction, and reacts with a diamine compound in the second stage.

The second operation is to gradually add the terminal carbonyl group blocking agent over a period of 10 minutes or more to a system in which the tetracarboxylic dianhydride is dissolved in an appropriate reaction solvent. A period of 20 minutes or more is more preferred, and a period of 30 minutes or more is more preferred. In addition, the method for adding may be continuous or intermittent. That is, a method of adding to a reaction system at a constant rate using a dropping funnel or the like, or a method of adding in portions at an appropriate interval is preferably applied.

The third operation is to use the terminal carbonyl group blocking agent dissolved in the reaction solvent in advance in the second operation. The concentration of the terminal carbonyl group blocking agent is 5 to 20% by weight when dissolved.

The concentration of the terminal carbonyl group blocking agent is more preferably 15% by weight or less, and further more preferably 10% by weight or less.

### Production Method 4:

The second production method is a method in which,
in the first stage, a diamine compound and tetracarboxylic acid are reacted to produce a resin having a structure represented by the general formula (15), and
in the second stage, the resin having a structure represented by the general formula (15) is reacted with a terminal carbonyl group blocking agent to produce a resin having a structure represented by the general formula (3).

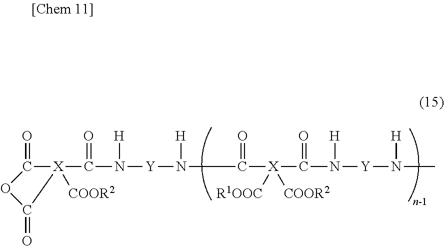

In the general formula (15), X, Y, R² and n are the same as those in the general formula (1).

In the reaction of the first stage, in order to produce a resin having a structure represented by the general formula (15), the number of moles of the tetracarboxylic acid is preferably 1.01 times or more the number of moles of the diamine compound, more preferably 1.05 times or more, still more preferably 1.1 times or more, still more preferably 1.2 times or more. If the number of moles is less than 1.01 times, the probability that the tetracarboxylic acid is located at the terminal end of the resin is reduced, and it is difficult to obtain a resin having a structure represented by the general formula (15).

In the reaction of the second stage, the method described in the production method 3 may be used as an operation for adding a terminal carbonyl group blocking agent. That is, the terminal carbonyl group blocking agent may be added over time, or the terminal carbonyl group blocking agent may be dissolved in an appropriate reaction solvent and then added.

As will be described later, the number of moles of the diamine compound to be used and the number of moles of the tetracarboxylic acid to be used are preferably equal. Therefore, the diamine compound is preferably added after the reaction of the second stage to make the number of moles of the diamine compound equal to the number of moles of tetracarboxylic acid.

Furthermore, the resin having a structure represented by the general formula (3) may be produced by using in combination the production methods 3 and 4.

As the terminal carbonyl group blocking agent, alcohol or thiol having 1 to 10 carbon atoms and water are preferably used. Among these, alcohol is preferred. Specific examples thereof include methyl alcohol, ethyl alcohol, n-propyl alcohol, n-butyl alcohol, n-pentyl alcohol, n-hexyl alcohol, n-heptyl alcohol, n-octyl alcohol, n-nonyl alcohol, n-decyl alcohol, isopropyl alcohol, isobutyl alcohol, sec-butyl alcohol, tert-butyl alcohol, isopentyl alcohol, sec-pentyl alcohol, tert-pentyl alcohol, isohexyl alcohol, sec-hexyl alcohol, cyclopropyl alcohol, cyclobutyl alcohol, cyclopentyl alcohol, cyclohexyl alcohol, cycloheptyl alcohol, cyclooctyl alcohol, norbornyl alcohol, adamantyl alcohol and the like.

Among these alcohols, isopropyl alcohol, cyclohexyl alcohol, tert-butyl alcohol, and tert-pentyl alcohol are more preferred, and tert-butyl alcohol is most preferred.

In addition, in the production method as described above, as the tetracarboxylic acid, corresponding acid dianhydride, active ester, active amide, or the like can also be used. As the diamine compound, corresponding trimethylsilylated diamine or the like can also be used. The carboxy group of the obtained resin may form a salt with an alkali metal ion, ammonium ion or imidazolium ion, or may be esterified with a hydrocarbon group having 1 to 10 carbon atoms or an alkylsilyl group having 1 to 10 carbon atoms.

The number of moles of the diamine compound to be used and the number of moles of the tetracarboxylic acid to be used are preferably equal. If they are equal, a resin film having high mechanical properties is easily obtained from the resin composition.

Examples of the reaction solvents include amides such as N-methyl-2-pyrrolidone, N-ethyl-2-pyrrolidone, N,N-dimethylformamide, N,N-dimethylacetamide, 3 -methoxy-N,N-dimethylpropionamide, 3 -butoxy-N,N-dimethylpropionamide, N-methyl-2-dimethylpropanamide, N-ethyl-2-methylpropanamide, N-methyl-2,2-dimethylpropanamide, N-methyl-2-methylbutanamide, N,N-dimethylisobutyramide, N,N-dimethyl-2-methylbutanamide, N,N-dimethyl-2,2-dimethylpropanamide, N-ethyl-N-methyl-2-methylpropanamide, N,N-dimethyl- 2-methylpentanamide, N,N-dimethyl-2,3-dimethylbutanamide, N,N-dimethyl-2-ethylbutanamide, N,N-diethyl-2-methylpropanamide, N,N-dimethyl-2,2-dimethylbutanamide, N-ethyl-N-methyl-2,2-dimethylpropanamide, N-methyl-N-propyl-2-methylpropanamide, N-methyl-N-(1-methylethyl)-2-methylpropanamide, N,N-diethyl-2,2-dimethylpropanamide, N,N-dimethyl-2,2-dimethylpentanamide, N-ethyl-N-(1-methylethyl)-2-methylpropanamide, N-methyl-N-(2-methylpropyl)-2-methylpropanamide, N-methyl-N-(1-methylethyl)-2,2-dimethylpropanamide, and N-methyl-N-(1-methylpropyl)-2-methylpropanamide, esters such as y-butyrolactone, ethyl acetate, propylene glycol monomethyl ether acetate, and ethyl lactate, ureas such as 1,3-dimethyl-2-imidazolidinone, N,N′-dimethylpropylene urea, 1,1,3,3-tetramethyl urea, sulfoxides such as dimethyl sulfoxide and tetramethylene sulfoxide, sulfones such as dimethyl sulfone and sulfolane, ketones such as acetone, methyl ethyl ketone, diisobutyl ketone, diacetone alcohol and cyclohexanone, ethers such as tetrahydrofuran, dioxane, propylene glycol monomethyl ether, propylene glycol monoethyl ether, diethylene glycol monomethyl ether, diethylene glycol monoethyl ether, diethylene glycol ethyl methyl ether, and diethylene glycol dimethyl ether, aromatic hydrocarbons such as toluene and xylene, alcohols such as methanol, ethanol and isopropanol, and water. One of these can be used alone, or two kinds or more can be used.

Moreover, the target resin composition can be obtained without the need of the resin isolation by using the same solvent as the one used in a resin composition for a reaction solvent, or adding a solvent after the reaction ends.

The obtained resin composition is preferably filtered using a filtration filter to remove particles. Examples of the filter pore size include, but are not limited to, 10 μm, 3 μm, 1 μm, 0.5 μm, 0.2 μm, 0.1 μm, 0.07 μm, and 0.05 μm. Examples of the material of the filter include polypropylene (PP), polyethylene (PE), nylon (NY), and polytetrafluoroethylene (PTFE), and polyethylene and nylon are preferred. The number of particles (particle size of 1 μm or more) in the resin composition is preferably 100 particles/mL or less. When the number of particles exceeds 100 particles/mL, the mechanical properties of the heat resistant resin film obtained from the resin composition deteriorate.

Since the filtered resin composition contains bubbles, if the filtered resin composition is used as it is for the formation of a film, craters and pinholes due to the bubbles are generated in the resin film, resulting in deterioration of the mechanical properties of the film. Therefore, the bubbles in the resin composition are preferably removed before the film is formed and then the resin composition is used for forming a resin film. Examples of the method for removing bubbles include vacuum degassing, centrifugal degassing, and ultrasonic degassing. However, since not only bubbles mixed in the resin composition but also gas dissolved in the resin composition can be removed, vacuum degassing is preferably performed. In particular, for the reasons described above, the degree of pressure reduction and time are preferably adjusted for the degassing in such a way that the partial pressure of dissolved oxygen in the resin composition is 10 Pa or more and less than 6000 Pa.

When the resin composition has a structure represented by the general formula (2), dicarbonate ester or dithiocarbonate ester is preferably used as a terminal amino group blocking agent. Therefore, carbon dioxide produced during the reaction of the terminal amino group blocking agent is also dissolved. This dissolved carbon dioxide appears as micro-sized bubbles when the coated film is dried under reduced pressure, and results in a defect inside the film and causes deterioration of mechanical properties.

Therefore, as described above, the bubbles in the resin composition are preferably removed before the film is formed and then the resin composition is used for forming the resin film.

### Method of Producing a Heat Resistant Resin Film

The method of producing the heat resistant resin film according to an embodiment of the present invention comprises a step in which a resin composition is coated on a substrate and then dried under reduced pressure.

Examples of the coating methods of the resin composition include spin coating, slit coating, dip coating, spray coating, printing, and the like. These may be combined, but the resin composition according to an embodiment of the present invention is most effective when the slit coating method is used. In the slit coating method, when the ratio of the viscous component of the resin composition is too high, that is, when the value of the tan δ of the resin composition is too large, there is a problem of lowered film thickness uniformity because the coated film flows at the edges after the resin composition is coated and before the resin composition is dried, and thus the coated film becomes thinned at the periphery. When the resin composition of the present invention is used, the film thickness of the coated film at the edges can be kept at the target film thickness, and a heat resistant resin film with good film thickness uniformity can be obtained.

Examples of the substrate to which the resin composition of the present invention is coated include, but not limited to, a wafer substrate such as silicon or gallium arsenide, a glass substrate such as sapphire glass, soda lime glass, or non-alkali glass, a metal substrate or a metal foil such as stainless steel or copper, a ceramic substrate, or the like.

Prior to coating, the support may be pretreated in advance. For example, a surface of the support is treated by a method such as spin coating, slit die coating, bar coating, dip coating, spray coating, or a steam treatment with a solution obtained by dissolving a pretreatment agent by 0.5 to 20% by mass in a solvent such as isopropanol, ethanol, methanol, water, tetrahydrofuran, propylene glycol monomethyl ether acetate, propylene glycol monomethyl ether, ethyl lactate, or diethyl adipate. If necessary, the resulting can be dried under reduced pressure, and then the reaction between the support and the pretreatment agent can proceed by heat treatment at 50° C. to 300° C.

Next, the coated film is dried under reduced pressure. In this case, it is common to dry the whole substrate on which the coated film is formed under reduced pressure. For example, the substrate on which the coated film is formed is placed on proxy pins arranged in a vacuum chamber, and the inside of the vacuum chamber is depressurized for dying under reduced pressure.

The rate of drying under reduced pressure depends on the vacuum chamber volume, the vacuum pump capacity, the pipe size between the chamber and the pump, or the like.

For example, the vacuum chamber is used under the condition that the pressure in the vacuum chamber is reduced to 50 Pa in 300 seconds without a coated substrate. The general duration for drying under reduced pressure is often about 60 to 100 seconds, and the ultimate pressure in the vacuum chamber at the end of the drying under reduced pressure is usually 60 Pa or less when the coated substrate is present. By setting the ultimate pressure to 60 Pa or less, the surface of the coated film can be in a dry state without any stickiness. Thus, the surface contamination and the generation of particles can be suppressed in the subsequent transport of the substrate. If the ultimate pressure is set too low, the gas contained in the resin composition expands and causes bubbles. Therefore, the ultimate pressure during drying under reduced pressure is preferably 10 Pa or more, and more preferably 40 Pa or more.

Moreover, in order to perform drying more reliably, drying by heating may be performed after drying under reduced pressure. Drying by heating is performed using a hot plate, an oven, infrared rays, or the like. In the case of using a hot plate, the coated film is held on a plate directly or a jig such as a proxy pin installed on the plate and then dried by heating.

Examples of materials of the proxy pin include metallic materials such as aluminum and stainless steel, and synthetic resins such as polyimide resins and “Teflon” (registered trademark). A proxy pin of any material can be used as long as it is heat resistant. The height of the proxy pin can be selected depending on the size of the support, the type of the solvent used in the varnish, the drying method, and the like, but is preferably about 0.1 to 10 mm. The heating temperature depends on the type of the solvent used in the varnish and the dry condition in the previous step, but is preferably in the range of room temperature to 180° C. for 1 minute to several hours.

When the resin composition of the present invention contains a photoacid generator, a pattern can be formed on the dried coated film by the method described below. The coated film is irradiated with actinic rays through a mask having a desired pattern and thus subjected to light exposure. The actinic rays used for the exposure include ultraviolet rays, visible rays, electron beams, X rays and the like, but in the present invention, the i-line (365 nm), h-line (405 nm) or g-line (436 nm) of a mercury lamp is preferably used. In the case of positive photosensitivity, the exposed portion is dissolved in a developing solution. In the case of negative photosensitivity, the exposed portion is cured and becomes insoluble in a developing solution.

After the exposure to light, a desired pattern is formed using a developing solution by removing an exposed portion in the case of a positive type or a non-exposed portion in the case of a negative type. The developing solution is, in both cases of positive and negative types, preferably an aqueous solution of an alkaline compound such as tetramethylammonium, diethanolamine, diethylaminoethanol, sodium hydroxide, potassium hydroxide, sodium carbonate, potassium carbonate, triethylamine, diethylamine, methylamine, dimethylamine, dimethylaminoethyl acetate, dimethylaminoethanol, dimethylaminoethyl methacrylate, cyclohexylamine, ethylenediamine, or hexamethylenediamine. In some cases, one or a mixture of several kinds of amides such as N-methyl-2-pyrrolidone, N,N-dimethylformamide, N,N-dimethylacetamide, dimethylacrylamide, and N,N-dimethylisobutyramide, esters such as γ-butyrolactone, ethyl lactate and propylene glycol monomethyl ether acetate, sulfoxides such as dimethyl sulfoxide, ketones such as cyclopentanone, cyclohexanone, isobutyl ketone and methyl isobutyl ketone, alcohols such as methanol, ethanol and isopropanol, and the like may be added to this alkaline aqueous solution. In the negative type, the above amides, esters, sulfoxides, ketones, alcohols and the like, which do not contain an alkaline aqueous solution, can be used alone or in combination of several kinds. It is common to perform a rinse treatment with water after development. An ester such as ethyl lactate and propylene glycol monomethyl ether acetate, an alcohol such as ethanol and isopropyl alcohol may be added to water for the rinse treatment.

Finally, a heat resistant resin film can be produced by heat treatment in the range of 180° C. or more and 600° C. or less and thus baking the coated film.

The obtained heat resistant resin film can be suitably used for a surface protective film and an interlayer insulating film of a semiconductor element, an insulating layer and a spacer layer of an organic electroluminescence element (organic EL element), a planarizing film of a thin film transistor substrate, an insulating layer of an organic transistor, a flexible printed substrate, a substrate for a flexible display, a substrate for a flexible electronic paper, a substrate for a flexible solar cell, a substrate for a flexible color filter, an electrode binder of a lithium ion secondary battery, a semiconductor adhesive, and the like.

Although the film thickness of the heat resistant resin film of the present invention is not particularly limited, for example, when the heat resistant resin film is used as a substrate for electronic devices, the film thickness is preferably 5 μm or more. The film thickness is more preferably 7 μm or more, and further more preferably 10 μm or more. With the film thickness of 5 μm or more, mechanical properties which are sufficient as a flexible display substrate is obtained.

The heat resistant resin film according to an embodiment of the present invention is suitably used as a substrate for electronic devices, for example, a flexible printed substrate, a substrate for a flexible display, a substrate for a flexible electronic paper, a substrate for a flexible solar cell, a substrate for a flexible color filter, and a substrate for a flexible touch panel and the like. In these applications, the preferred tensile elongation and maximum tensile stress of the heat resistant resin film are 15% or more and 150 MPa or more, respectively.

### Method of Producing an Electronic Device

The method of using the heat resistant resin film obtained by the production method of the present invention as a substrate of an electronic device is explained below. The method comprises a step of forming a resin film by the above-described method and a step of forming an electronic device on the resin film.

First of all, a heat resistant resin film is produced on a support such as a glass substrate by the production method of the present invention.

Subsequently, an electronic device is formed by, for example, forming a driving element or an electrode on the heat resistant resin film. For example, when the electronic device is an image display device, an electronic device is formed by forming a pixel driving element or a colored pixel.

When the image display device is an organic EL display, a TFT which is an image driving element, a first electrode, an organic EL light emitting element, a second electrode, and a sealing film are sequentially formed. In the case of a color filter, after a black matrix is formed as necessary, colored pixels such as red, green, and blue are formed.

When the electronic device is a touch panel, a transparent conductive layer can be formed on the resin film of the present invention to form a transparent conductive film, and the transparent conductive films can be laminated on each other by using an adhesive or a glue.

A gas barrier film may be provided between the heat resistant resin film and the electronic device as necessary. By providing the gas barrier film, it is possible to prevent moisture and oxygen from passing through the heat resistant resin film from the outside of the image display device, which causes deterioration of pixel driving elements and colored pixels. As the gas barrier film, a single inorganic film such as a silicon oxide film (SiOx), a silicon nitrogen film (SiNy), or a silicon oxynitride film (SiOxNy), or a laminate of several types of inorganic films is used. The gas barrier film is formed by a method such as chemical vapor deposition (CVD) or physical vapor deposition (PVD). Furthermore, as the gas barrier film, a film in which these inorganic films and organic films such as polyvinyl alcohol are alternately laminated can be used.

The heat resistant resin film is peeled from the support to obtain an electronic device containing the heat resistant resin film. Examples of the method for peeling the film at the interface between the support and the heat resistant resin film include a method using a laser, a mechanical peeling method, a method of etching the support, and the like. In the method using a laser, peeling can be performed without damaging the image display element by irradiating the support such as a glass substrate with a laser from the side where the image display element is not formed. Moreover, a primer layer can be provided between the support and the heat resistant resin film for easier peeling.

### EXAMPLES

The present invention is explained below by way of Examples, but the present invention is not limited to these Examples.

### (1) Measurement of the Loss Tangent (tan δ) of the Resin Composition

Using a rheometer (ARES-G2 manufactured by TA Instruments) with a cone plate cell having a cone diameter of 50 mm and a cone angle of 0.02 rad, the storage elastic modulus G′ and the loss elastic modulus G″ were measured under conditions of the measurement temperature of 22° C. and an angular frequency of 10 rad/s. The value of tan δ was calculated from the obtained values of G′ and G′ according to the formula (I).

tan δ=G″/G′ (I)

### (2) Evaluation of the Weight Average Molecular Weight

Using gel permeation chromatography (Waters-2690, manufactured by Nihon Waters K.K.), the weight average molecular weight was determined based on polystyrene as a standard. For the column, TOSOH TXK-GEL α-2500 and α-4000 manufactured by Tosoh Corporation were used, and N-methyl-2-pyrrolidone was used for the mobile phase.

### (3) Measurement of the Viscosity

Measurement was performed at 25° C. using a viscometer (TVE-22H manufactured by Toki Sangyo Co., Ltd.).

### (4) Measurement of the Change Rate of Viscosity

The varnish obtained in each Synthesis Example was left at 23° C. for 30 days in a clean bottle (manufactured by AICELLO CORPORATION). The varnish after the storage was used to measure the viscosity according to the method (3), and the change rate of viscosity was determined according to the following formula.

Change rate of viscosity (%)=(viscosity after storage−viscosity before storage)/viscosity before storage×100

### (5) Measurement of Dissolved Oxygen in the Resin Composition

Using a dissolved gas analyzer equipped with a dissolved oxygen sensor (the main body “Orbisphere 510” and the oxygen sensor “29552A” manufactured by Hach Japan), the measurement part of the dissolved oxygen sensor was immersed in the varnish after the vacuum degassing treatment to measure the partial pressure of the dissolved oxygen.

### (6) Production of a Heat Resistant Resin Film

A resin composition was coated using a slit coater (TS coater manufactured by Toray Engineering Co., Ltd.) on a glass substrate of 300 mm×350 mm in such a way that the film thickness would be 10 μm after imidation by heating. The coating speed was 1 m/min. After coating, the obtained film was put into a vacuum chamber and dried under reduced pressure at 40° C. for 300 seconds. The pressure was adjusted so that the pressure in the chamber would be 50 Pa after 300 seconds. Then, the obtained film was dried for 8 minutes at 120° C. using a hotplate. Using an inert oven (INH-21CD manufactured by Koyo Thermo Systems Co., Ltd.), the temperature was raised from 50° C. in increments of 4° C./min in a nitrogen atmosphere (oxygen concentration of 20 ppm or less), and the obtained film was heated at 500° C. for 30 minutes.

Subsequently, the obtained film was immersed in hydrofluoric acid for 4 minutes to peel off the resulting heat resistant resin film from the glass substrate and air-dried.

(7) Evaluation of the appearance of the Heat Resistant Resin Film (presence or absence of rupture of the film)

The heat resistant resin film produced according to the method described in (6) was visually observed to confirm the presence or absence of rupture of the film.

### (8) Evaluation of the Film Thickness Uniformity of the Heat Resistant Resin Film

The film thickness of the heat resistant resin film produced according to the method described in (6) was measured using a film thickness measuring device FTM manufactured by Toray Engineering Co., Ltd. Except for a region of 10 mm on each side from the outer periphery of the substrate, the remaining portion was divided into 100 parts, which were used as 100 measurement sites. The film thickness uniformity was calculated by the following formula. The film thickness uniformity of 3.5% or less is good, and the film thickness uniformity of 3% or less is particularly good.

Average film thickness value=total film thickness of 100 sites/100

Film thickness uniformity (%)=[{(maximum film thickness−minimum film thickness)/2}/average film thickness value]×100.

### (9) Measurement of Tensile Elongation, Maximum Tensile Stress and Young's Modulus

Using a Tensilon universal material testing machine (RTM-100 manufactured by ORIENTEC CORPORATION), the measurement was performed in accordance with Japanese Industrial Standard (JIS K 7127: 1999).

The measurement conditions were as follows: a test piece width of 10 mm, a chuck interval of 50 mm, a testing rate of 50 mm/min, and number of measurements n=10.

### (10) Evaluation of Bending Resistance

Using a MIT type bending resistance testing machine (MIT-DA manufactured by Toyo Seiki Seisaku-sho, Ltd.), the number of bending until the sample broke was measured in accordance with Japanese Industrial Standard (JIS P 8115: 2001). The measurement conditions were as follows: a load of 1.0 kgf, a bending angle of 135 degrees, a bending speed of 175 times per minute, a bending radius of 0.38 mm, and evaluation of up to 100,000 times of bending.

### (11) Measurement of Coefficient of Thermal Expansion (CTE)

Using a thermomechanical analyzer (EXSTAR 6000 TMA/SS 6000 manufactured by SII Nano Technology Inc.), the measurement was performed under a nitrogen gas stream. The method for raising the temperature followed the conditions as below. In the first stage, the temperature was raised to 150° C. at a rising rate of 5° C./min to remove the adsorbed water of the sample, followed by, in the second stage, air-cooling to room temperature at a lowering rate of 5° C./min. In the third stage, the main measurement was performed at a rising rate of 5° C./min to obtain a CTE. The CTE is an average value obtained at 50° C. to 200° C. in the third stage. The polyimide film produced by (6) was used for the measurement.

### (12) Measurement of 1% Weight Loss Temperature (Heat Resistance)

Measurement was performed under a nitrogen gas stream using a thermogravimetric measuring device (TGA-50 manufactured by Shimadzu Corporation). The method for raising the temperature followed the conditions as below. In the first stage, the temperature was raised to 350° C. at a rising rate of 3.5° C./min to remove the adsorbed water of the sample, followed by, in the second stage, cooling to room temperature at a lowering rate of 10° C./min. In the third stage, the main measurement was performed at a rising rate of 10° C./min to obtain a 1% weight loss temperature. The polyimide film produced by (6) was used for the measurement.

The abbreviations of compounds used in Examples are described below.
BPDA: 3,3′,4,4′-biphenyltetracarboxylic dianhydride
PMDA: pyromellitic dianhydride
PDA: p-phenylenediamine
DAE: 4,4′-diaminodiphenyl ether
CHDA: trans-1,4-cyclohexanediamine
DIBOC: Di-tert-butyl dicarbonate
NMP: N-methyl-2-pyrrolidone
DMIB: N,N-dimethylisobutyramide.

### Synthesis Example 1

A thermometer and a stirring rod with stirring blades were set in a four-necked flask having a capacity of 500 mL. Then, 127 g of NMP was added under a dry nitrogen gas stream. Subsequently, 10.81 g (100.0 mmol) of PDA was added while stirring at room temperature, and the container used for the addition was washed with 10 g of NMP. After it was confirmed that PDA was dissolved, the mixture was cooled to 10° C. or lower. After the mixture was cooled, a solution obtained by diluting 1.75 g (8.00 mmol) of DIBOC with 20 g of NMP was added dropwise over 10 minutes. One hour after the dropwise addition was completed, 29.13 g (99.00 mmol) of BPDA was added and the container used for the addition was washed with 10 g of NMP. The mixture was cooled 4 hours later. The reaction solution was filtered through a filter having a filter pore size of 0.2 um, and then degassed under reduced pressure at a pressure of 2000 Pa for 1 hour to obtain a varnish.

### Synthesis Example 2

A thermometer and a stirring rod with stirring blades were set in a four-necked flask having a capacity of 500 mL. Then, 157 g of NMP was added under a dry nitrogen gas stream. Subsequently, 10.81 g (100.0 mmol) of PDA was added while stirring at room temperature, and the container used for the addition was washed with 10 g of NMP. After it was confirmed that PDA was dissolved, the mixture was cooled to 10° C. or lower. After the mixture was cooled, a solution obtained by diluting 1.75 g (8.00 mmol) of DIBOC with 20 g of NMP was added dropwise over 10 minutes. One hour after the dropwise addition was completed, 29.13 g (99.00 mmol) of BPDA was added, and the container used for the addition was washed with 10 g of NMP. The mixture was cooled 4 hours later. The reaction solution was filtered through a filter having a filter pore size of 0.2 μm, and then degassed under reduced pressure at a pressure of 2000 Pa for 1 hour to obtain a varnish.

### Synthesis Example 3

A thermometer and a stirring rod with stirring blades were set in a four-necked flask having a capacity of 500 mL. Then, 128 g of NMP was added under a dry nitrogen gas stream. Subsequently, 10.81 g (100.0 mmol) of PDA was added while stirring at room temperature, and the container used for the addition was washed with 10 g of NMP. After it was confirmed that PDA was dissolved, the mixture was cooled to 10° C. or lower. After the mixture was cooled, a solution obtained by diluting 1.75 g (8.00 mmol) of DIBOC with 20 g of NMP was added dropwise over 10 minutes. One hour after the dropwise addition was completed, 28.54 g (97.00 mmol) of BPDA was added and the container used for the addition was washed with 10 g of NMP. The mixture was cooled 4 hours later. The reaction solution was filtered through a filter having a filter pore size of 0.2 um, and then degassed under reduced pressure at a pressure of 2000 Pa for 1 hour to obtain a varnish.

### Synthesis Example 4

A thermometer and a stirring rod with stirring blades were set in a four-necked flask having a capacity of 500 mL. Then, 222 g of NMP was added under a dry nitrogen gas stream and the temperature was raised to 40° C. After the temperature was raised, 10.81 g (100.0 mmol) of PDA was added while stirring, and the container used for the addition was washed with 10 g of NMP. After it was confirmed that PDA was dissolved, 28.54 g (97.00 mmol) of BPDA was added and the container used for the addition was washed with 10 g of NMP. The mixture was cooled 4 hours later. The reaction solution was filtered through a filter having a filter pore size of 0.2 μm, and then degassed under reduced pressure at a pressure of 2000 Pa for 1 hour to obtain a varnish.

### Synthesis Example 5

A thermometer and a stirring rod with stirring blades were set in a four-necked flask having a capacity of 500 mL. Then, 294 g of NMP was added under a dry nitrogen gas stream. Subsequently, 20.02 g (100.0 mmol) of DAE was added while stirring at room temperature, and the container used for the addition was washed with 10 g of NMP. After it was confirmed that DAE was dissolved, the mixture was cooled to 10° C. or lower. After the mixture was cooled, a solution obtained by diluting 1.75 g (8.00 mmol) of DIBOC with 20 g of NMP was added dropwise over 10 minutes. One hour after the dropwise addition was completed, 21.59 g (99.00 mmol) of PMDA was added and the container used for the addition was washed with 10 g of NMP. The mixture was cooled 4 hours later. The reaction solution was filtered through a filter having a filter pore size of 0.2 um, and then degassed under reduced pressure at a pressure of 2000 Pa for 1 hour to obtain a varnish.

### Synthesis Example 6

A thermometer and a stirring rod with stirring blades were set in a four-necked flask having a capacity of 500 mL. Then, 266 g of DMIB was added under a dry nitrogen gas stream. Subsequently, 10.81 g (100.0 mmol) of PDA was added while stirring at room temperature, and the container used for the addition was washed with 10 g of DMIB. After it was confirmed that PDA was dissolved, the mixture was cooled to 10° C. or lower. After the mixture was cooled, a solution obtained by diluting 1.75 g (8.00 mmol) of DIBOC with 20 g of DMIB was added dropwise over 10 minutes. One hour after the dropwise addition was completed, 29.13 g (99.00 mmol) of BPDA was added and the container used for the addition was washed with 10 g of DMIB. The mixture was cooled 4 hours later. The reaction solution was filtered through a filter having a filter pore size of 0.2 um, and then degassed under reduced pressure at a pressure of 2000 Pa for 1 hour to obtain a varnish.

### Synthesis Example 7

A thermometer and a stirring rod with stirring blades were set in a four-necked flask having a capacity of 500 mL. Then, 127 g of NMP was added under a dry nitrogen gas stream. Subsequently, 10.81 g (100.0 mmol) of PDA was added while stirring at room temperature, and the container used for the addition was washed with 10 g of NMP. After it was confirmed that PDA was dissolved, the mixture was cooled to 10° C. or lower. After the mixture was cooled, a solution obtained by diluting 1.75 g (8.00 mmol) of DIBOC with 20 g of NMP was added dropwise over 10 minutes. One hour after the dropwise addition was completed, 29.13 g (99.00 mmol) of BPDA was added, and the container used for the addition was washed with 10 g of NMP. The mixture was cooled 4 hours later. The reaction solution was filtered through a filter having a filter pore size of 0.2 μm, and thus a varnish was obtained.

### Synthesis Example 8

A thermometer and a stirring rod with stirring blades were set in a four-necked flask having a capacity of 500 mL. Then, 200 g of NMP was added under a dry nitrogen gas stream. Subsequently, 11.42 g (100.0 mmol) of CHDA was added while stirring at room temperature, and the container used for the addition was washed with 10 g of NMP. After it was confirmed that CHDA was dissolved, the mixture was cooled to 10° C. or lower. After the mixture was cooled, a solution obtained by diluting 1.75 g (8.00 mmol) of DIBOC with 20 g of NMP was added dropwise over 10 minutes. One hour after the dropwise addition was completed, 29.13 g (99.00 mmol) of BPDA was added, and the container used for the addition was washed with 10 g of NMP. The mixture was cooled 4 hours later. The reaction solution was filtered through a filter having a filter pore size of 0.2 um, and then degassed under reduced pressure at a pressure of 2000 Pa for 1 hour to obtain a varnish.

### Synthesis Example 9

A thermometer and a stirring rod with stirring blades were set in a four-necked flask having a capacity of 500 mL. Then, 149 g of NMP was added under a dry nitrogen gas stream. Subsequently, 29.13 g (99.0 mmol) of BPDA was added while stirring at room temperature, and the container used for the addition was washed with 10 g of NMP. After it was confirmed that BPDA was dissolved, the mixture was cooled to 10° C. or lower. After the mixture was cooled, a solution obtained by diluting 0.23 g (5.00 mmol) of ethanol with 20 g of NMP was added dropwise over 10 minutes. One hour after the dropwise addition was completed, 10.81 g (100.00 mmol) of PDA was added and the container used for the addition was washed with 10 g of NMP. The mixture was cooled 4 hours later. The reaction solution was filtered through a filter having a filter pore size of 0.2 μm, and then degassed under reduced pressure at a pressure of 2000 Pa for 1 hour to obtain a varnish.

### Synthesis Example 10

A thermometer and a stirring rod with stirring blades were set in a four-necked flask having a capacity of 200 mL. Then, 60 g of NMP was added under a dry nitrogen gas stream. Subsequently, 12.01 g (60.00 mmol) of DAE was added while stirring at room temperature, and the container used for the addition was washed with 10 g of NMP. After it was confirmed that DAE was dissolved, the mixture was cooled to 10° C. or lower. After the mixture was cooled, a solution obtained by diluting 1.31 g (6.00 mmol) of DIBOC with 5 g of NMP was added over 1 minute, and the container used for the addition was washed with 5 g of NMP. After the addition, the temperature was raised to 40° C. After the temperature was raised, 12.43 g (57.00 mmol) of PMDA was added, and the container used for the addition was washed with 10 g of NMP. The mixture was cooled 2 hours later and thus obtained as a varnish.

### Synthesis Example 11

A thermometer and a stirring rod with stirring blades were set in a four-necked flask having a capacity of 200 mL. Then, 65 g of NMP was added under a dry nitrogen gas stream. Subsequently, 6.488 g (60.00 mmol) of PDA was added while stirring at room temperature, and the container used for the addition was washed with 10 g of NMP. The temperature was raised to 30° C. After it was confirmed that PDA was dissolved, a solution obtained by diluting 0.504 g (6.00 mmol) of diketene with 5 g of NMP was added over 1 minute, and the container used for the addition was washed with 5 g of NMP. After the addition, the temperature was raised to 60° C. After the temperature was raised, 17.65 g (60.00 mmol) of BPDA was added, and the container used for the addition was washed with 10 g of NMP. The mixture was cooled 4 hours later and thus obtained as a varnish.

### Synthesis Example 12

A thermometer and a stirring rod with stirring blades were set in a four-necked flask having a capacity of 500 mL. Then, 203 g of NMP was added under a dry nitrogen gas stream and the temperature was raised to 40° C. After the temperature was raised, 10.81 g (100.0 mmol) of PDA was added while stirring, and the container used for the addition was washed with 10 g of NMP. After it was confirmed that PDA was dissolved, 28.54 g (97.00 mmol) of BPDA was added and the container used for the addition was washed with 10 g of NMP. The mixture was cooled 4 hours later. The reaction solution was filtered through a filter having a filter pore size of 0.2 μm, and then degassed under reduced pressure at a pressure of 2000 Pa for 1 hour to obtain a varnish.

### Synthesis Example 13

A thermometer and a stirring rod with stirring blades were set in a four-necked flask having a capacity of 500 mL. Then, 339 g of NMP was added under a dry nitrogen gas stream and the temperature was raised to 40° C. After the temperature was raised, 10.81 g (100.0 mmol) of PDA was added while stirring, and the container used for the addition was washed with 10 g of NMP. After it was confirmed that PDA was dissolved, 29.13 g (99.00 mmol) of BPDA was added and the container used for the addition was washed with 10 g of NMP. The mixture was cooled 4 hours later. The reaction solution was filtered through a filter having a filter pore size of 0.2 μm, and then degassed under reduced pressure at a pressure of 2000 Pa for 1 hour to obtain a varnish.

### Synthesis Example 14

A thermometer and a stirring rod with stirring blades were set in a four-necked flask having a capacity of 500 mL. Then, 199 g of NMP was added under a dry nitrogen gas stream. Subsequently, 10.81 g (100.0 mmol) of PDA was added while stirring at room temperature, and the container used for the addition was washed with 10 g of NMP. After it was confirmed that PDA was dissolved, the mixture was cooled to 10° C. or lower. After the mixture was cooled, a solution obtained by diluting 1.75 g (8.00 mmol) of DIBOC with 20 g of NMP was added dropwise over 10 minutes. One hour after the dropwise addition was completed, 29.13 g (99.00 mmol) of BPDA was added, and the container used for the addition was washed with 10 g of NMP. The mixture was cooled 4 hours later. The reaction solution was filtered through a filter having a filter pore size of 0.2 μm, and then degassed under reduced pressure at a pressure of 2000 Pa for 1 hour to obtain a varnish.

### Synthesis Example 15

A thermometer and a stirring rod with stirring blades were set in a four-necked flask having a capacity of 500 mL. Then, 269 g of DMIB was added under a dry nitrogen gas stream and the temperature was raised to 40° C. After the temperature was raised, 10.81 g (100.0 mmol) of PDA was added while stirring, and the container used for the addition was washed with 10 g of DMIB. After it was confirmed that PDA was dissolved, 28.54 g (97.00 mmol) of BPDA was added and the container used for the addition was washed with 10 g of DMIB. The mixture was cooled 4 hours later. The reaction solution was filtered through a filter having a filter pore size of 0.2 μm, and then degassed under reduced pressure at a pressure of 2000 Pa for 1 hour to obtain a varnish.

### Synthesis Example 16

A thermometer and a stirring rod with stirring blades were set in a four-necked flask having a capacity of 500 mL. Then, 335 g of DMIB was added under a dry nitrogen gas stream. Subsequently, 10.81 g (100.0 mmol) of PDA was added while stirring at room temperature, and the container used for the addition was washed with 10 g of DMIB. After it was confirmed that PDA was dissolved, the mixture was cooled to 10° C. or lower. After the mixture was cooled, a solution obtained by diluting 1.75 g (8.00 mmol) of DIBOC with 20 g of DMIB was added dropwise over 10 minutes. One hour after the dropwise addition was completed, 29.13 g (99.00 mmol) of BPDA was added and the container used for the addition was washed with 10 g of DMIB. The mixture was cooled 4 hours later. The reaction solution was filtered through a filter having a filter pore size of 0.2 μm, and then degassed under reduced pressure at a pressure of 2000 Pa for 1 hour to obtain a varnish.

### Synthesis Example 17

A thermometer and a stirring rod with stirring blades were set in a four-necked flask having a capacity of 300 mL. Then, 90 g of NMP was added under a dry nitrogen gas stream and the temperature was raised to 40° C. After the temperature was raised, 10.81 g (100.0 mmol) of PDA was added while stirring, and the container used for the addition was washed with 10 g of NMP. After it was confirmed that PDA was dissolved, a solution obtained by diluting 2.183 g (10.00 mmol) of DIBOC with 20 g of NMP was added dropwise over 30 minutes. One hour after the dropwise addition was completed, 29.42 g (100.00 mmol) of BPDA was added and the container used for the addition was washed with 10 g of NMP. The mixture was cooled 4 hours later. The mixture was diluted by 17 g of NMP, and then was filtered through a filter having a filter pore size of 0.2 μm, and thus a varnish was obtained.

### Synthesis Example 18

A thermometer and a stirring rod with stirring blades were set in a four-necked flask having a capacity of 300 mL. Then, 90 g of NMP was added under a dry nitrogen gas stream and the temperature was raised to 40° C. After the temperature was raised, 10.81 g (100.0 mmol) of PDA was added while stirring, and the container used for the addition was washed with 10 g of NMP. After it was confirmed that PDA was dissolved, a solution obtained by diluting 3.274 g (15.00 mmol) of DIBOC with 20 g of NMP was added dropwise over 10 minutes. One hour after the dropwise addition was completed, 29.42 g (100.00 mmol) of BPDA was added and the container used for the addition was washed with 10 g of NMP. The mixture was cooled 4 hours later. The reaction solution was filtered through a filter having a filter pore size of 0.2 μm, and thus a varnish was obtained.

### Example 1

A: The loss tangent (tan δ), the weight average molecular weight, the viscosity, the change rate of viscosity, and the amount of dissolved oxygen of the varnish obtained in Synthesis Example 1 were measured by the methods described above.
B: A heat resistant resin film was prepared using the varnish obtained in Synthesis Example 1, and according to the methods described above, the appearance and the film thickness uniformity were evaluated, and the tensile elongation, the tensile maximum stress, the Young's modulus, the bending resistance, the coefficient of thermal expansion (CTE) and 1% weight loss temperature were measured.

### Examples 2 to 9, Comparative Examples 1 to 9

As described in Tables 1 and 2, the varnishes obtained in Synthesis Examples 2 to 18 were used for the same evaluation as in Example 1. The evaluation results of Examples 1 to 9 and Comparative Examples 1 to 9 are shown in Tables 1 and 2.

TABLE 1

| Example | | | 1 | 2 | 3 | 4 | 5 | 6 | 7 | 8 | 9 |
|---|---|---|---|---|---|---|---|---|---|---|---|
| Synthesis Example | | | 1 | 2 | 3 | 4 | 5 | 6 | 7 | 8 | 9 |
| Acid | BPDA | Molar ratio | 99 | 99 | 97 | 97 | | 99 | 99 | 99 | 99 |
| dianhydride | PMDA | | | | | | 99 | | | | |
| Diamine | PDA | | 100 | 100 | 100 | 100 | | 100 | 100 | | 100 |
| compound | DAE | | | | | | 100 | | | | |
| | CHDA | | | | | | | | | 100 | |
| Terminal | DIBOC | | 8 | 8 | 8 | | 8 | 8 | 8 | 8 | |
| blocking | Diketene | | | | | | | | | | |
| agent | Ethanol | | | | | | | | | | 5 |

| | | | | | | | | | | |
|---|---|---|---|---|---|---|---|---|---|---|
| Solid content concentration | % by weight | 20 | 17.5 | 20 | 14 | 13 | 12 | 20 | 15 | 17.5 |
| Solvent | | NMP | NMP | NMP | NMP | NMP | DMIB | NMP | NMP | NMP |
| Boiling point of solvent | ° C. | 202 | 202 | 202 | 202 | 202 | 175 | 202 | 202 | 202 |
| Items for vanish evaluation | Unit | | | | | | | | | |
| tan δ | | 251 | 474 | 311 | 201 | 210 | 223 | 252 | 322 | 462 |
| Weight average molecular | | 22100 | 22300 | 18100 | 56500 | 25900 | 19100 | 21800 | 31000 | 23200 |
| weight | | | | | | | | | | |
| Viscosity | mPa · s | 3000 | 1050 | 2210 | 2150 | 3000 | 1500 | 3000 | 1500 | 1090 |
| Change rate of viscosity | % | 1.5 | 2.1 | 1.4 | 2.2 | 1.9 | 3.2 | 2.1 | 1.7 | −8.8 |
| (M-10000) x V^{2.5} x 10⁻¹² | | 5.96 | 0.44 | 1.86 | 9.97 | 7.84 | 0.79 | 5.82 | 1.83 | 0.52 |
| Oxygen partial pressure | Pa | 4800 | 4300 | 4200 | 5200 | 5100 | 4900 | 19300 | 4500 | 4500 |
| Items for film evaluation | Unit | | | | | | | | | |
| Rupture of film | | Absent | Absent | Absent | Absent | Absent | Absent | Absent | Absent | Absent |
| Film thickness uniformity | % | 2.1 | 3.1 | 2.8 | 2.5 | 2.2 | 2.4 | 2.1 | 2.2 | 2.9 |
| Tensile elongation | % | 28 | 28 | 22 | 21 | 105 | 18 | 15 | 25 | 29 |
| Maximum tensile stress | MPa | 310 | 308 | 210 | 321 | 183 | 215 | 130 | 288 | 301 |
| Bending resistance | Times | >100000 | >100000 | >100000 | 46591 | >100000 | >100000 | >100000 | >100000 | >100000 |
| Young's modulus | GPa | 7.1 | 6.8 | 6.9 | 7 | 1.8 | 6.3 | 7 | 4.8 | 6.8 |
| Coefficient of thermal | ppm/° C. | 4.8 | 4.6 | 4.5 | 4.6 | 38 | 4.2 | 4.8 | 21 | 4.4 |
| expansion | | | | | | | | | | |
| 1% weight loss temperature | ° C. | 581 | 582 | 578 | 581 | 567 | 571 | 581 | 493 | 583 |

TABLE 2

| Comparative Example | | | 1 | 2 | 3 | 4 | 5 | 6 | 7 | 8 | 9 |
|---|---|---|---|---|---|---|---|---|---|---|---|
| Synthesis Example | | | 10 | 11 | 12 | 13 | 14 | 15 | 16 | 17 | 18 |
| Acid | BPDA | Molar | | 100 | 97 | 99 | 99 | 97 | 99 | 100 | 100 |
| dianhydride | PMDA | ratio | 95 | | | | | | | | |
| Diamine | PDA | | | 100 | 100 | 100 | 100 | 100 | 100 | 100 | 100 |
| compound | DAE | | 100 | | | | | | | | |
| | CHDA | | | | | | | | | | |
| Terminal | DIBOC | | 10 | | | | 8 | | 8 | 10 | 15 |
| blocking agent | Diketene | | | 10 | | | | | | | |
| | Ethanol | | | | | | | | | | |

| | | | | | | | | | | |
|---|---|---|---|---|---|---|---|---|---|---|
| Solid content concentration | % by | 19.7 | 20.6 | 15 | 10 | 16 | 12 | 10 | 22.4 | 25.0 |
| | weight | | | | | | | | | |
| Solvent | | NMP | NMP | NMP | NMP | NMP | DMIB | DMIB | NMP | NMP |
| Boiling point of solvent | ° C. | 202 | 202 | 202 | 202 | 202 | 175 | 175 | 202 | 202 |
| Items for vanish evaluation | Unit | | | | | | | | | |
| tan δ | | 121 | 148 | 119 | 60 | 550 | 146 | 610 | 551 | —*² |
| Weight average molecular | | 30300 | 26100 | 56500 | 89500 | 22000 | 34000 | 18500 | 11200 | 8200 |
| weight | | | | | | | | | | |
| Viscosity | mPa · s | 5100 | 4200 | 3000 | 3000 | 600 | 3000 | 550 | 2000 | 2000 |
| Change rate of viscosity | % | 1.7 | 2.1 | 1.9 | 2.5 | 2.2 | 1.6 | 1.9 | 4.5 | 1.6 |
| (M-10000) x V^{2.5} x 10⁻¹² | | 37.71 | 18.41 | 22.92 | 39.19 | 0.11 | 11.83 | 0.06 | 0.21 | −0.32 |
| Oxygen partial pressure | Pa | 18900 | 19100 | 4900 | 5500 | 4200 | 5200 | 4100 | 4900 | 4800 |
| Items for film evaluation | Unit | | | | | | | | | |
| Rupture of film | | Present | Present | Present | Present | Absent | Present | Absent | Absent | Absent |
| Film thickness uniformity | % | N.D.*¹ | N.D.*¹ | N.D.*¹ | N.D.*¹ | 6.8 | N.D.*¹ | 8.6 | 6.3 | 11.2 |
| Tensile elongation | % | N.D.*¹ | N.D.*¹ | N.D.*¹ | N.D.*¹ | 25 | N.D.*¹ | 23 | 24 | 25 |
| Maximum tensile stress | MPa | N.D.*¹ | N.D.*¹ | N.D.*¹ | N.D.*¹ | 311 | N.D.*¹ | 301 | 310 | 306 |
| Bending resistance | Times | N.D.*¹ | N.D.*¹ | N.D.*¹ | N.D.*¹ | >100000 | N.D.*¹ | >100000 | >100000 | >100000 |
| Young's modulus | GPa | N.D.*¹ | N.D.*¹ | N.D.*¹ | N.D.*¹ | 7.1 | N.D.*¹ | 6.6 | 6.7 | 6.9 |
| Coefficient of thermal expansion | ppm/° C. | N.D.*¹ | N.D.*¹ | N.D.*¹ | N.D.*¹ | 4.6 | N.D.*¹ | 5.1 | 4.5 | 4.7 |
| 1% weight loss temperature | ° C. | N.D.*¹ | N.D.*¹ | N.D.*¹ | N.D.*¹ | 581 | N.D.*¹ | 568 | 579 | 569 |

*¹No Data (Rupture of film occurred during drying under reduced pressure, and a baked film could not be obtained.)
*²Since storage elastic modulus G is 0 Pa, tan δ could not be calculated.

As shown in Tables 1 and 2, compared with Comparative Examples 1 to 9, Examples 1 to 9 resulted in a resin film which had no rupture of the film with excellent film thickness uniformity. In addition, when the terminal blocking agent was used (Examples 1 to 3 and Examples 5 to 9), the resulting resin film was more excellent in bending resistance than in the case where the terminal blocking agent was not used (Example 4). Furthermore, when DIBOC, that is, a terminal amino group blocking agent was used as a terminal blocking agent (Examples 1 to 3 and Examples 5 to 8), the resin composition had a small change rate of viscosity and excellent storage stability compared with the case where ethanol, that is, a terminal carbonyl group blocking agent was used as the terminal blocking agent (Example 9).

### Example 10

### Production and Evaluation of an Organic EL Display

On the heat resistant resin film obtained in B of Example 1, a gas barrier film made of a laminate of SiO₂ and Si₃N₄ was formed by CVD. Subsequently, a TFT was formed, and an insulating film made of Si₃N₄ and covering the TFT was formed. After a contact hole was formed in the insulating film, a wiring connected to the TFT through the contact hole was formed.

Further, a planarizing film was formed in order to planarize the unevenness due to the formation of the wiring. Then, a first electrode made of ITO was formed on the obtained planarizing film and connected to the wiring. A resist was coated, prebaked, exposed through a mask having a desired pattern, and developed. Using this resist pattern as a mask, pattern processing was performed by wet etching using an ITO etchant. Then, the resist pattern was peeled off using a resist stripping solution (mixed solution of monoethanolamine and diethylene glycol monobutyl ether). The substrate after the resist pattern was peeled was washed with water and dehydrated by heating to obtain an electrode substrate with a planarizing film. Then, an insulating film having a shape covering the periphery of the first electrode was formed.

Further, a hole transport layer, an organic light emitting layer, and an electron transport layer were sequentially deposited through a desired pattern mask in a vacuum deposition apparatus. Then, a second electrode made of Al/Mg was formed on the entire surface of the top substrate. Further, a sealing film made of a laminate of SiO₂ and Si₃N₄ was formed by CVD. The glass substrate was irradiated with a laser (wavelength: 308 nm) from the side where the heat resistant resin film was not formed, and peeled off at the interface with the heat resistant resin film.

As described above, an organic EL display device formed on the heat resistant resin film was obtained. When voltage was applied through the drive circuit, good light emission was exhibited.

### Example 11

### Production and Evaluation of a Touch Panel

### (1) Production of ITO Pattern

An ITO film having a thickness of 150 nm was formed on the heat resistant resin film obtained in B of Example 8 by sputtering, and a resist was then coated, prebaked, exposed through a mask having a desired pattern, and developed. Using this resist pattern as a mask, pattern processing was performed by wet etching using an ITO etchant. Then, the resist pattern was peeled off using a resist stripping solution (mixed solution of monoethanolamine and diethylene glycol monobutyl ether). The substrate after the resist pattern was peeled was washed with water and dehydrated by heating to obtain a conductive substrate with an ITO film.

### (2) Production of Transparent Insulating Film

A negative-type photosensitive resin composition NS-E2000 (manufactured by Toray Industries, Inc.)

was coated on the substrate prepared in (1), prebaked, exposed through a mask having a desired pattern, and developed. Furthermore, curing by heating was performed in a nitrogen atmosphere to form a transparent insulating film.

### (3) Fabrication of MAM Wiring

On the substrate prepared in (2), MAM wiring was prepared in the same manner as in (1), using molybdenum and aluminum as targets and an acid chemical solution (weight ratio: H₃PO₄/HNO₃/AcOH/H₂O=6) as an etching solution.

### (4) Production of Transparent Protective Film

A transparent protective film was produced on the substrate produced in (3) in the same manner as in (2). When a continuity test was performed on the connection part using a digital multimeter (CDM-09N: Custom Corporation), current continuity was confirmed.

1. A resin composition comprising (a) at least one resin selected from polyimides and polyimide precursors, and (b) a solvent, wherein the loss tangent (tan δ), represented by the following formula (I) and determined by a dynamic viscoelasticity measurement under the conditions of a temperature of 22° C. and an angular frequency of 10 rad/s, is 150 or more and less than 550;
tan δ=G″/G′ (I)
(wherein G′ represents the storage elastic modulus of said resin composition, and G″ represents the loss elastic modulus of said resin composition).

2. A resin composition comprising (a) at least one resin selected from polyimides and polyimide precursors, and (b) a solvent, wherein V and M satisfy the following formula (II) with V being the viscosity (cp) at 25° C. and M being the weight average molecular weight of the component (a);
0.3≤(M−10,000)×V^{2.5}×10⁻¹²≤10 (II)

3. The resin composition according to claim 2, wherein the loss tangent (tan δ), represented by the following formula (I) and determined by a dynamic viscoelasticity measurement under the conditions of a temperature of 22° C. and an angular frequency of 10 rad/s, is 150 or more and less than 550;
tan δ=G″/G′ (I)
(wherein G′ represents the storage elastic modulus of said resin composition, and G″ represents the loss elastic modulus of said resin composition).

4. The resin composition according to claim 1, wherein said (b) solvent comprises a solvent having a boiling point of 160° C. or higher and 220° C. or lower at atmospheric pressure.

5. The resin composition according to claim 1, wherein the concentration of said component (a) is 5% by weight or more and 20% by weight or less with respect to 100% by weight of said resin composition.

6. The resin composition according to claim 1, wherein the weight average molecular weight of said (a) at least one resin selected from polyimides and polyimide precursors is 20,000 or more and less than 40,000.

7. The resin composition according to claim 1, wherein said component (a) comprises a resin represented by the following general formula (1); 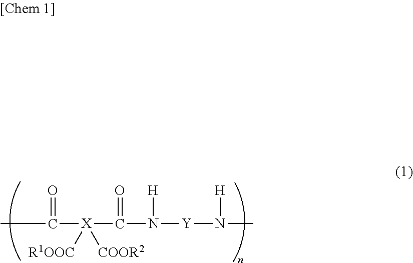
(wherein in the general formula (1), X represents a tetravalent tetracarboxylic acid residue having 2 or more carbon atoms, and Y represents a divalent diamine residue having 2 or more carbon atoms, n represents a positive integer, and R¹ and R² represent each independently a hydrogen atom, a hydrocarbon group having 1 to 10 carbon atoms, or an alkylsilyl group having 1 to 10 carbon atoms).

8. The resin composition according to claim 7, wherein said resin represented by the general formula (1) is a resin represented by the following general formula (2); 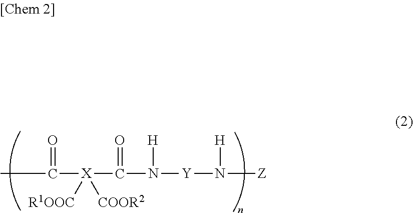
(wherein in the general formula (2), X, Y, R¹, R² and n are the same as in the general formula (1), and Z represents the chemical formula (10)), 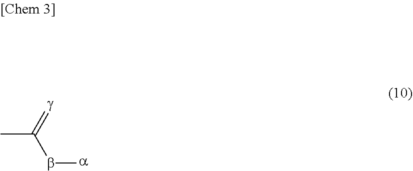
(wherein in the chemical formula (10), a represents a monovalent hydrocarbon group having 2 or more carbon atoms, and β and γ represent each independently an oxygen atom or a sulfur atom).

9. The resin composition according to claim 7, wherein said resin represented by the general formula (1) is a resin represented by the following general formula (3); 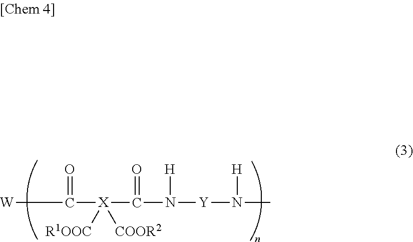
(wherein in the general formula (3), X, Y, R¹, R² and n are the same as in the general formula (1), and W represents the chemical formula (11)),
[Chem 5]
—ϵ—δ (11)
(wherein in the chemical formula (11), δ represents a monovalent hydrocarbon group having 1 or more carbon atoms or a hydrogen atom, and E represents an oxygen atom or a sulfur atom).

10. The resin composition according to claim 7, wherein X is selected from the following.

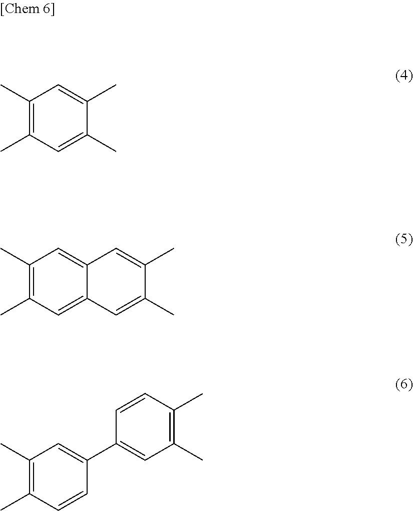

11. The resin composition according to claim 7, wherein Y is selected from the following; 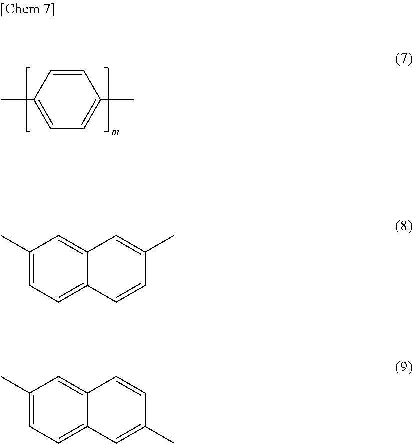
(wherein m represents a positive integer).

12. The resin composition according to claim 1, wherein the partial pressure of dissolved oxygen in said resin composition is less than 6000 Pa.

13. A method of producing a resin film comprising the step of coating the resin composition according to claim 1 on a substrate, followed by drying under reduced pressure.

14. A method of producing an electronic device, comprising the steps of forming a resin film by the method according to claim 13, and forming an electronic device on said resin film.

15. The method of producing an electronic device according to claim 14, wherein said electronic device is an image display device, an organic EL display, or a touch panel.
